(19) United States
(12) Patent Application Publication
(10) Pub. No.: US 2025/0265983 A1
(43) Pub. Date: Aug. 21, 2025

(54) DRIVING CIRCUIT, DRIVING METHOD, AND DISPLAY DEVICE

(71) Applicants: CHENGDU BOE OPTOELECTRONICS TECHNOLOGY CO., LTD., Chengdu, Sichuan, (CN); BOE TECHNOLOGY GROUP CO., LTD., Beijing (CN); Beijing BOE Technology Development Co., Ltd., Beijing (CN)

(72) Inventors: Dan CAO, Beijing (CN); Yonglin GUO, Beijing (CN); Ziyang YU, Beijing (CN); Qingqing YAN, Beijing (CN); Quanyong GU, Beijing (CN); Gukhwan SONG, Beijing (CN); Zhiliang JIANG, Beijing (CN)

(21) Appl. No.: 18/993,648

(22) PCT Filed: May 22, 2024
(86) PCT No.: PCT/CN2024/094704

§ 371 Date: Jan. 13, 2025

(30) Foreign Application Priority Data
Mar. 29, 2023 (WO) PCT/CN2023/084683

(51) Int. Cl. G09G 3/3225

(52) U.S. Cl. CPC G09G 3/3225; G09G 2310/061; G09G 2310/08

(57) ABSTRACT

A driving circuit, driving method, and display device are provided. The drive circuit includes output circuit and inverting circuit; the output circuit provides driving output signal via the driving output terminal based on data voltage under control of switch control signal and output control signal; the inverting circuit includes N stages of inverters, N is positive integer; input terminal of first inverter is electrically connected to the driving output terminal, and output terminal of N-th inverter is electrically connected to driving signal output terminal; if N is greater than 1, output terminal of m-th inverter is electrically connected to input terminal of (m+1)-th inverter, m is positive integer less than N; the inverter inverts signal received by its input terminal to obtain inverted signal and output it via its output terminal. The drive circuit has high output stability.

### CROSS-REFERENCE TO RELATED APPLICATION

This application is the U.S. national phase of PCT Application No. PCT/CN2024/094704 filed on May 22, 2024, which claims a priority to PCT Application No. PCT/CN2023/084683 filed on Mar. 29, 2023, which is incorporated in its entirety by reference herein.

### TECHNICAL FIELD

The present disclosure relates to the field of display technologies, and in particular to a driving circuit, a driving method and a display device.

### BACKGROUND

In most cases, a conventional OLED (organic light emitting diode) pixel driving method includes that: reset, data writing and light emission phase are completed once in each frame, with the entire screen maintaining a consistent refresh rate. However, with advancements in time and technology, it has become possible to use different driving frequencies for the same display. In the low-frequency regions, during frame maintaining, some signals do not need to be reset repeatedly, nor do they require the writing of data voltage signals. Therefore, by controlling source control circuits of these signals and turning off certain TFTs (thin film transistor) in the circuit, power consumption can be reduced. The above technology is known as partial refresh. In the related technologies, output stability of the driving circuit that provides a driving signal is low.

### SUMMARY

In an aspect, embodiments of the present disclosure provide a driving circuit, including an output circuit and an inverting circuit;
the output circuit is electrically connected to an output control terminal, a switch control terminal, a data line and a driving output terminal, and is configured to provide a driving output signal via the driving output terminal based on a data voltage provided by the data line under control of a switch control signal provided by the switch control terminal and an output control signal provided by the output control terminal;
the inverting circuit includes N stages of inverters, N is a positive integer;
an input terminal of a first inverter is electrically connected to the driving output terminal, and an output terminal of an N-th inverter is electrically connected to a driving signal output terminal;
in a case that N is greater than 1, an output terminal of an m-th inverter is electrically connected to an input terminal of an (m+1)-th inverter, and m is a positive integer less than N; and
the inverter is configured to invert a signal received by the input terminal of the inverter to obtain an inverted signal, and output the inverted signal via the output terminal of the inverter.

Optionally, the output circuit includes a first data writing circuit, a differential control circuit, an input control circuit and an output control circuit;
the first data writing circuit is electrically connected to the switch control terminal, a first data line and a first differential control node, and is configured to write a first data voltage provided by the first data line into the first differential control node and maintain a potential of the first differential control node under control of the switch control signal provided by the switch control terminal;
the differential control circuit is electrically connected to the first differential control node, a second differential control node, an input node, a first output node, and a second output node, and is configured to control a potential of the first output node and a potential of the second output node based on a potential of the input node under control of the potential of the first differential control node and a potential of the second differential control node;
the input control circuit is electrically connected to the output control terminal, the input node and a first voltage terminal, and is configured to control connection or disconnection between the input node and the first voltage terminal under control of the output control signal provided by the output control terminal; and
the output control circuit is electrically connected to the output control terminal, the first output node, the second output node and the driving output terminal, and is configured to generate the driving output signal and provide the driving output signal via the driving output terminal based on the potential of the first output node and the potential of the second output node under control of the output control signal.

Optionally, the output control circuit includes a latch circuit and a set circuit;
the set circuit is electrically connected to the output control terminal, an intermediate node, the driving output terminal and a second voltage terminal, and is configured to control connection or disconnection between the intermediate node and the second voltage terminal and control connection or disconnection between the driving output terminal and the second voltage terminal under control of the output control signal; and
the latch circuit is electrically connected to the first output node, the second output node, the intermediate node, the driving output terminal and the second voltage terminal, and is configured to control a potential of the driving output terminal based on the potential of the first output node and the potential of the second output node under control of a potential of the intermediate node.

Optionally, the output circuit further includes a second data writing circuit;
the second data writing circuit is electrically connected to the switch control terminal, a second data line and the second differential control node, and is configured to write a second data voltage provided by the second data line into the second differential control node and maintain the potential of the second differential control node under control of the switch control signal provided by the switch control terminal.

Optionally, the driving circuit in at least one embodiment of the present disclosure further includes a switch control circuit;
the switch control circuit is electrically connected to an on-off control terminal, a first output control node and a second output control node, and is configured to control connection or disconnection between the first output control node and the second output control node under control of an on-off control signal provided by the on-off control terminal;
the first output control node is electrically connected to the driving output terminal, and the second output control node is electrically connected to the input terminal of the first inverter; or,
the first output control node is electrically connected to the output terminal of the N-th inverter, and the second output control node is electrically connected to the driving signal output terminal; or,
N is greater than 1, the first output control node is electrically connected to the output terminal of the m-th inverter, and the second output control node is electrically connected to the input terminal of the (m+1)-th inverter.

Optionally, the latch circuit is configured to control connection or disconnection between the second output node and the driving output terminal and connection or disconnection between the driving output terminal and the second voltage terminal under control of the potential of the intermediate node, and to control connection or disconnection between the first output node and the intermediate node and connection or disconnection between the intermediate node and the second voltage terminal under control of the potential of the driving output terminal.

Optionally, a frame time includes a blanking period, the blanking period includes an off phase, and the off phase includes a setting period;
the set circuit is configured to control connection between the intermediate node and the second voltage terminal and control connection between the driving output terminal and the second voltage terminal under control of the output control signal during the setting period; and
the switch control circuit is configured to control disconnection between the first output control node and the second output control node under control of the on-off control signal during the off phase.

Optionally, N is equal to 1, the inverting circuit includes the first inverter, and the first inverter includes a first transistor and a second transistor
a gate electrode of the first transistor is electrically connected to the input terminal of the first inverter, a first electrode of the first transistor is electrically connected to a first voltage terminal, and a second electrode of the first transistor and a first electrode of the second transistor are both electrically connected to the driving signal output terminal;
a gate electrode of the second transistor is electrically connected to the input terminal of the first inverter, and a second electrode of the second transistor is electrically connected to a second voltage terminal; and
the first transistor is a p-type transistor, and the second transistor is an n-type transistor.

Optionally, N is equal to 2, the inverting circuit includes the first inverter and a second inverter, the first inverter includes a first transistor and a second transistor, and the second inverter includes a third transistor and a fourth transistor;
a gate electrode of the first transistor is electrically connected to the input terminal of the first inverter, a first electrode of the first transistor is electrically connected to a first voltage terminal, and a second electrode of the first transistor and a first electrode of the second transistor are both electrically connected to an input terminal of the second inverter;
a gate electrode of the second transistor is electrically connected to the input terminal of the first inverter, and a second electrode of the second transistor is electrically connected to a second voltage terminal;
a gate electrode of the third transistor and a gate electrode of the fourth transistor are both electrically connected to the input terminal of the second inverter, a first electrode of the third transistor is electrically connected to the first voltage terminal, and a second electrode of the third transistor and a first electrode of the fourth transistor are both electrically connected to the driving signal output terminal;
a second electrode of the fourth transistor is electrically connected to the second voltage terminal; and
the first transistor is a p-type transistor, the second transistor is an n-type transistor; the third transistor is a p-type transistor, and the fourth transistor is an n-type transistor.

Optionally, the first data writing circuit includes a fifth transistor and a first capacitor;
a gate electrode of the fifth transistor is electrically connected to the switch control terminal, a first electrode of the fifth transistor is electrically connected to the first data line, and a second electrode of the fifth transistor is electrically connected to the first differential control node; and
a first terminal of the first capacitor is electrically connected to the first differential control node, and a second terminal of the first capacitor is electrically connected to a second voltage terminal.

Optionally, the second data writing circuit includes a sixth transistor and a second capacitor, a gate electrode of the sixth transistor is electrically connected to the switch control terminal, a first electrode of the sixth transistor is electrically connected to the second data line, and a second electrode of the sixth transistor is electrically connected to the second differential control node; and
a first terminal of the second capacitor is electrically connected to the second differential control node, and a second terminal of the second capacitor is electrically connected to the second voltage terminal.

Optionally, the switch control circuit includes a seventh transistor;
a gate electrode of the seventh transistor is electrically connected to the on-off control terminal, a first electrode of the seventh transistor is electrically connected to the first output control node, and a second electrode of the seventh transistor is electrically connected to the second output control node.

Optionally, the input control circuit includes an eighth transistor, and the differential control circuit includes a ninth transistor and a tenth transistor;
a gate electrode of the eighth transistor is electrically connected to the output control terminal, a first electrode of the eighth transistor is electrically connected to the first voltage terminal, and a second electrode of the eighth transistor is electrically connected to the input node;
a gate electrode of the ninth transistor is electrically connected to the first differential control node, a first electrode of the ninth transistor is electrically connected to the input node, and a second electrode of the ninth transistor is electrically connected to the first output node; and
a gate electrode of the tenth transistor is electrically connected to the second differential control node, a first electrode of the tenth transistor is electrically connected to the input node, and a second electrode of the tenth transistor is electrically connected to the second output node.

Optionally, the set circuit includes an eleventh transistor and a twelfth transistor;
a gate electrode of the eleventh transistor is electrically connected to the output control terminal, a first electrode of the eleventh transistor is electrically connected to the intermediate node, and a second electrode of the eleventh transistor is electrically connected to the second voltage terminal; and
a gate electrode of the twelfth transistor is electrically connected to the output control terminal, a first electrode of the twelfth transistor is electrically connected to the driving output terminal, and a second electrode of the twelfth transistor is electrically connected to the second voltage terminal.

Optionally, the eighth transistor is a p-type transistor, and the eleventh transistor and the twelfth transistor are n-type transistors; or, the eighth transistor is an n-type transistor, and the eleventh transistor and the twelfth transistor are p-type transistors.

Optionally, the latch circuit includes a thirteenth transistor, a fourteenth transistor, a fifteenth transistor, and a sixteenth transistor;
a gate electrode of the thirteenth transistor is electrically connected to the driving output terminal, a first electrode of the thirteenth transistor is electrically connected to the intermediate node, and a second electrode of the thirteenth transistor is electrically connected to the second voltage terminal;
a gate electrode of the fourteenth transistor is electrically connected to the intermediate node, a first electrode of the fourteenth transistor is electrically connected to the driving output terminal, and a second electrode of the fourteenth transistor is electrically connected to the second voltage terminal;
a gate electrode of the fifteenth transistor is electrically connected to the driving output terminal, a first electrode of the fifteenth transistor is electrically connected to the first output node, and a second electrode of the fifteenth transistor is electrically connected to the intermediate node; and
a gate electrode of the sixteenth transistor is electrically connected to the intermediate node, a first electrode of the sixteenth transistor is electrically connected to the second output node, and a second electrode of the sixteenth transistor is electrically connected to the driving output terminal.

Optionally, the thirteenth transistor and the fourteenth transistor are n-type transistors, and the fifteenth transistor and the sixteenth transistor are p-type transistors.

In a second aspect, embodiments of the present disclosure provide a driving method, applied to the above driving circuit, and the driving method includes:
providing, by the output circuit, the driving output signal via the driving output terminal based on the data voltage under control of the switch control signal and the output control signal; and
inverting, by the inverter included in the inverting circuit, the signal received by the input terminal of the inverter, to obtain the inverted signal, and outputting the inverted signal via the output terminal of the inverter.

Optionally, the output circuit includes a first data writing circuit, a differential control circuit, an input control circuit and an output control circuit, the output control circuit includes a latch circuit and a set circuit, a frame time includes a blanking period, the blanking period includes a setting period and an output phase, the setting period includes a reset phase, a data writing phase and a potential maintaining phase, and the driving method includes:
in the reset phase, controlling, by the set circuit, connection between an intermediate node and a second voltage terminal and connection between the driving output terminal and the second voltage terminal under control of the output control signal;
in the data writing phase, writing, by the first data writing circuit, a first data voltage provided by a first data line into a first differential control node under control of the switch control signal;
in the potential maintaining phase, maintaining, by the first data writing circuit, a potential of the first differential control node; and
in the output phase, controlling, by the input control circuit, connection between an input node and a first voltage terminal under control of the output control signal; controlling, by the differential control circuit, a potential of a first output node and a potential of a second output node based on a potential of the input node under control of the potential of the first differential control node and a potential of the second differential control node; controlling, by the latch circuit, the potential of the driving output terminal based on the potential of the first output node and the potential of the second output node under control of a potential of the intermediate node.

Optionally, the output circuit further includes a second data writing circuit, and the driving method further includes:
in the data writing phase, writing, by the second data writing circuit, a second data voltage provided by a second data line into the second differential control node under control of the switch control signal; and
in the potential maintaining phase, maintaining, by the second data writing circuit, the potential of the second differential control node.

Optionally, the driving circuit further includes a switch control circuit, the blanking period includes an off phase, the off phase includes the setting period, and the driving method further includes:
in the off phase, controlling, by the switch control circuit, disconnection between the first output control node and the second output control node under control of an on-off control signal.

In a third aspect, embodiments of the present disclosure provide a display device, including the above driving circuit.

### BRIEF DESCRIPTION OF THE DRAWINGS

FIG. 1 is a structural diagram of a driving circuit according to at least one embodiment of the present disclosure;

FIG. 2 is a structural diagram of a driving circuit according to at least one embodiment of the present disclosure;

FIG. 3 is a structural diagram of a driving circuit according to at least one embodiment of the present disclosure;

FIG. 4 is a structural diagram of a driving circuit according to at least one embodiment of the present disclosure;

FIG. 5 is a structural diagram of a driving circuit according to at least one embodiment of the present disclosure;

FIG. 6 is a structural diagram of a driving circuit according to at least one embodiment of the present disclosure;

FIG. 7A is a structural diagram of a driving circuit according to at least one embodiment of the present disclosure;

FIG. 7B is a structural diagram of a driving circuit according to at least one embodiment of the present disclosure;

FIG. 8A is a structural diagram of a driving circuit according to at least one embodiment of the present disclosure;

FIG. 8B is a structural diagram of a driving circuit according to at least one embodiment of the present disclosure;

FIG. 9A is a structural diagram of a driving circuit according to at least one embodiment of the present disclosure;

FIG. 9B is a structural diagram of a driving circuit according to at least one embodiment of the present disclosure;

FIG. 10A is a structural diagram of a driving circuit according to at least one embodiment of the present disclosure;

FIG. 10B is a structural diagram of a driving circuit according to at least one embodiment of the present disclosure;

FIG. 11A is a structural diagram of a driving circuit according to at least one embodiment of the present disclosure;

FIG. 11B is a structural diagram of a driving circuit according to at least one embodiment of the present disclosure;

FIG. 12A is a structural diagram of a driving circuit according to at least one embodiment of the present disclosure;

FIG. 12B is a structural diagram of a driving circuit according to at least one embodiment of the present disclosure;

FIG. 13A is a structural diagram of a driving circuit according to at least one embodiment of the present disclosure;

FIG. 13B is a structural diagram of a driving circuit according to at least one embodiment of the present disclosure;

FIG. 14A is a structural diagram of a driving circuit according to at least one embodiment of the present disclosure;

FIG. 14B is a structural diagram of a driving circuit according to at least one embodiment of the present disclosure;

FIG. 15A is a structural diagram of a driving circuit according to at least one embodiment of the present disclosure;

FIG. 15B is a structural diagram of a driving circuit according to at least one embodiment of the present disclosure;

FIG. 16A is a structural diagram of a driving circuit according to at least one embodiment of the present disclosure;

FIG. 16B is a structural diagram of a driving circuit according to at least one embodiment of the present disclosure;

FIG. 17 is a structural diagram of a driving circuit according to at least one embodiment of the present disclosure;

FIG. 18 is a structural diagram of a driving circuit according to at least one embodiment of the present disclosure;

FIG. 19 is a structural diagram of a driving circuit according to at least one embodiment of the present disclosure;

FIG. 20 is a structural diagram of a driving circuit according to at least one embodiment of the present disclosure;

FIG. 21A is a circuit diagram of a driving circuit according to at least one embodiment of the present disclosure;

FIG. 21B is an operation timing diagram of at least one embodiment of the driving circuit shown in FIG. 21A;

FIG. 21C is an operation timing diagram of at least one embodiment of the driving circuit shown in FIG. 21A;

FIG. 21D is a circuit diagram of at least one embodiment of a pixel circuit;

FIG. 22A is a circuit diagram of a driving circuit according to at least one embodiment of the present disclosure;

FIG. 22B is an operation timing diagram of at least one embodiment of the driving circuit shown in FIG. 22A;

FIG. 22C is an operation timing diagram of at least one embodiment of the driving circuit shown in FIG. 22A;

FIG. 22D is a waveform diagram of a light emitting control signal provided by each row light emitting control line;

FIG. 23A is a circuit diagram of a driving circuit according to at least one embodiment of the present disclosure;

FIG. 23B is an operation timing diagram of at least one embodiment of the driving circuit shown in FIG. 23A;

FIG. 23C is an operation timing diagram of at least one embodiment of the driving circuit shown in FIG. 23A;

FIG. 23D is an operation timing diagram of at least one embodiment of the driving circuit shown in FIG. 23A;

FIG. 24 is a circuit diagram of a driving circuit according to at least one embodiment of the present disclosure;

FIG. 25 is a circuit diagram of a driving circuit according to at least one embodiment of the present disclosure;

FIG. 26A is a circuit diagram of a driving circuit according to at least one embodiment of the present disclosure;

FIG. 26B is an operation timing diagram of at least one embodiment of the driving circuit shown in FIG. 26A;

FIG. 27 is a circuit diagram of a driving circuit according to at least one embodiment of the present disclosure;

FIG. 28 is a circuit diagram of a driving circuit according to at least one embodiment of the present disclosure;

FIG. 29A is a circuit diagram of a driving circuit according to at least one embodiment of the present disclosure;

FIG. 29B is an operation timing diagram of at least one embodiment of the driving circuit shown in FIG. 29A;

FIG. 30 is a circuit diagram of a driving circuit according to at least one embodiment of the present disclosure;

FIG. 31A is a circuit diagram of a driving circuit according to at least one embodiment of the present disclosure;

FIG. 31B is an operation timing diagram of at least one embodiment of the driving circuit shown in FIG. 31A;

FIG. 32 is a circuit diagram of a driving circuit according to at least one embodiment of the present disclosure;

FIG. 33 is a circuit diagram of a driving circuit according to at least one embodiment of the present disclosure;

FIG. 34 is a circuit diagram of a driving circuit according to at least one embodiment of the present disclosure;

FIG. 35 is a circuit diagram of a driving circuit according to at least one embodiment of the present disclosure;

FIG. 36 is a circuit diagram of a driving circuit according to at least one embodiment of the present disclosure;

FIG. 37 is a circuit diagram of a driving circuit according to at least one embodiment of the present disclosure;

FIG. 38 is a circuit diagram of a driving circuit according to at least one embodiment of the present disclosure;

FIG. 39 is a circuit diagram of a driving circuit according to at least one embodiment of the present disclosure;

FIG. 40 is a circuit diagram of a driving circuit according to at least one embodiment of the present disclosure;

FIG. 41 is a circuit diagram of a driving circuit according to at least one embodiment of the present disclosure;

FIG. 42 is a circuit diagram of a driving circuit according to at least one embodiment of the present disclosure;

FIG. 43 is a circuit diagram of a driving circuit according to at least one embodiment of the present disclosure; and

FIG. 44 is a circuit diagram of a driving circuit according to at least one embodiment of the present disclosure.

### DETAILED DESCRIPTION

The technical solutions in embodiments of the present disclosure are described clearly and completely in conjunction with drawings in the embodiments of the present disclosure. Apparently, the described embodiments are merely a part of rather than all the embodiments of the present disclosure. All other embodiments obtained by a person ordinary skilled in the art based on the embodiments of the present disclosure without any creative efforts fall within the protection scope of the present disclosure.

The transistors used in all embodiments of the present disclosure may be thin film transistors, field effect transistors, or other devices having the same characteristics. In the embodiments of the present disclosure, in order to distinguish two terminals of a transistor other than a gate electrode, one of the terminals is referred to as a first terminal, and the other is referred to as a second terminal.

In practical operation, when the transistor is a thin film transistor or a field effect transistor, the first electrode may be a drain electrode, and the second electrode may be a source electrode; or the first electrode may be a source electrode, and the second electrode may be a drain electrode.

The driving circuit in the embodiments of the present disclosure includes an output circuit and an inverting circuit;
the output circuit is electrically connected to an output control terminal, a switch control terminal, a data line and a driving output terminal, and is configured to provide a driving output signal via the driving output terminal based on a data voltage provided by the data line under control of a switch control signal provided by the switch control terminal and an output control signal provided by the output control terminal;
the inverting circuit includes N stages of inverters, N is a positive integer;
an input terminal of a first inverter is electrically connected to the driving output terminal, and an output terminal of an N-th inverter is electrically connected to a driving signal output terminal;
in a case that N is greater than 1, an output terminal of an m-th inverter is electrically connected to an input terminal of an (m+1)-th inverter, and m is a positive integer less than N; and
the inverter is configured to invert a signal received by the input terminal of the inverter to obtain an inverted signal, and output the inverted signal via the output terminal of the inverter.

The driving circuit in the embodiments of the present disclosure adopts the inverting circuit. In a case that the inverting circuit includes one stage of inverter, partial low refresh can be achieved. In a case that the inverting circuit includes two stages of inverters, the driving signal provided by the driving signal output terminal can be stabilized.

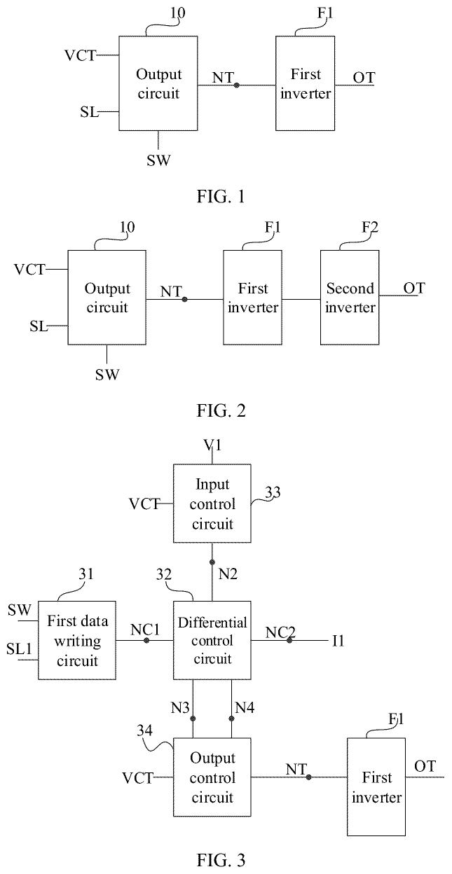

As shown in FIG. 1, the driving circuit in the embodiments of the present disclosure includes an output circuit 10 and an inverting circuit 11.

The output circuit 10 is electrically connected to an output control terminal VCT, a switch control terminal SW, a data line SL and a driving output terminal NT, and is configured to provide a driving output signal via the driving output terminal NT based on a data voltage provided by the data line SL under control of a switch control signal provided by the switch control terminal SW and an output control signal provided by the output control terminal VCT.

The inverting circuit includes a first inverter F1.

An input terminal of the first inverter F1 is electrically connected to the driving output terminal NT, and an output terminal of the first inverter F1 is electrically connected to a driving signal output terminal OT.

The first inverter F1 is configured to invert a signal received by its input terminal to obtain an inverted signal, and output the inverted signal via the output terminal of the first inverter F1.

In at least one embodiment of the driving circuit shown in FIG. 1, N is equal to 1.

As shown in FIG. 2, the driving circuit in the embodiments of the present disclosure includes an output circuit 10 and an inverting circuit 11.

The output circuit 10 is electrically connected to an output control terminal VCT, a switch control terminal SW, a data line SL and a driving output terminal NT, and is configured to provide a driving output signal via the driving output terminal NT based on a data voltage provided by the data line SL under control of a switch control signal provided by the switch control terminal SW and an output control signal provided by the output control terminal VCT.

The inverting circuit includes a first inverter F1 and a second inverter F2.

An input terminal of the first inverter F1 is electrically connected to the driving output terminal NT, and an output terminal of the first inverter F1 is electrically connected to an input terminal of the second inverter F2.

An output terminal of the second inverter F2 is electrically connected to a driving signal output terminal OT.

The first inverter F1 is configured to invert a signal received by its input terminal to obtain a first inverted signal, and output the first inverted signal via the output terminal of the first inverter F1.

The second inverter F2 is configured to invert a signal received by its input terminal to obtain a second inverted signal, and output the second inverted signal via the output terminal of the second inverter F2.

In at least one embodiment shown in FIG. 2, N is equal to 2.

In at least one embodiment of the present disclosure, the output circuit includes a first data writing circuit, a differential control circuit, an input control circuit and an output control circuit
the first data writing circuit is electrically connected to the switch control terminal, a first data line and a first differential control node, and is configured to write a first data voltage provided by the first data line into the first differential control node and maintain a potential of the first differential control node under control of the switch control signal provided by the switch control terminal;
the differential control circuit is electrically connected to the first differential control node, a second differential control node, an input node, a first output node, and a second output node, and is configured to control a potential of the first output node and a potential of the second output node based on a potential of the input node under control of the potential of the first differential control node and a potential of the second differential control node;
the input control circuit is electrically connected to the output control terminal, the input node and a first voltage terminal, and is configured to control connection or disconnection between the input node and the first voltage terminal under control of the output control signal provided by the output control terminal; and
the output control circuit is electrically connected to the output control terminal, the first output node, the second output node and the driving output terminal, and is configured to generate the driving output signal and provide the driving output signal via the driving output terminal based on the potential of the first output node and the potential of the second output node under control of the output control signal.

Optionally, the first voltage terminal may be a high voltage terminal.

As shown in FIG. 3, based on at least one embodiment of the driving circuit shown in FIG. 1, the output circuit includes a first data writing circuit 31, a differential control circuit 32, an input control circuit 33 and an output control circuit 34.

The first data writing circuit 31 is electrically connected to the switch control terminal SW, a first data line SL1 and a first differential control node NC1, and is configured to write a first data voltage provided by the first data line SL1 into the first differential control node NC1 and maintain a potential of the first differential control node NC1 under control of the switch control signal provided by the switch control terminal SW.

The second differential control node NC2 is electrically connected to an initial voltage terminal I1, and the initial voltage terminal I1 is configured to provide an initial voltage Vinit.

The differential control circuit 32 is electrically connected to the first differential control node NC1, a second differential control node NC2, an input node N2, a first output node N3 and a second output node N4, and is configured to control a potential of the first output node N3 and a potential of the second output node N4 based on a potential of the input node N2 under control of the potential of the first differential control node NC1 and a potential of the second differential control node NC2.

The input control circuit 33 is electrically connected to the output control terminal VCT, the input node N2 and a first voltage terminal V1, and is configured to control connection or disconnection between the input node N2 and the first voltage terminal V1 under control of the output control signal provided by the output control terminal VCT.

The output control circuit 34 is electrically connected to the output control terminal VCT, the first output node N3, the second output node N4 and the driving output terminal NT, and is configured to generate the driving output signal and provide the driving output signal via the driving output terminal NT based on the potential of the first output node N3 and the potential of the second output node N4 under control of the output control signal.

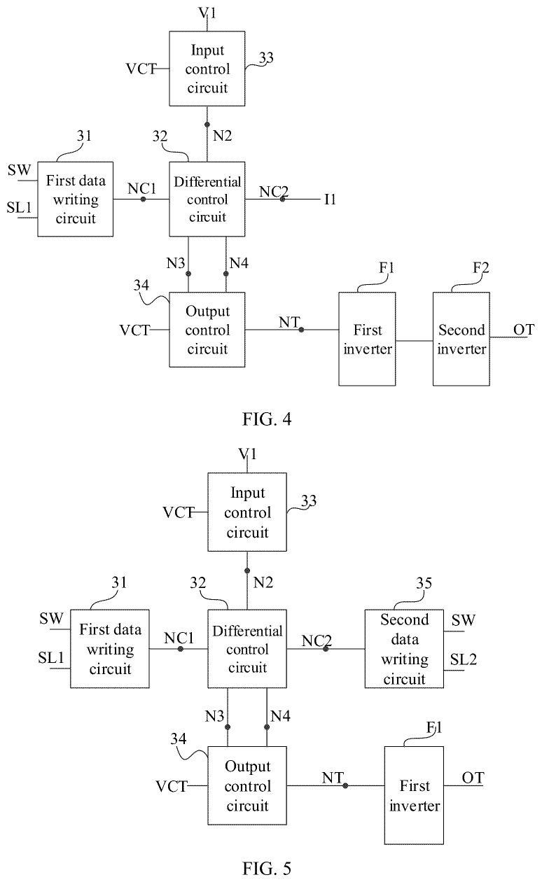

As shown in FIG. 4, based on at least one embodiment of the driving circuit shown in FIG. 2, the output circuit includes a first data writing circuit 31, a differential control circuit 32, an input control circuit 33 and an output control circuit 34.

The first data writing circuit 31 is electrically connected to the switch control terminal SW, a first data line SL1 and a first differential control node NC1, and is configured to write a first data voltage provided by the first data line SL1 into the first differential control node NC1 and maintain a potential of the first differential control node NC1 under control of the switch control signal provided by the switch control terminal SW.

The second differential control node NC is electrically connected to an initial voltage terminal I1, and the initial voltage terminal I1 is configured to provide an initial voltage Vinit.

The differential control circuit 32 is electrically connected to the first differential control node NC1, a second differential control node NC2, an input node N2, a first output node N3 and a second output node N4, and is configured to control a potential of the first output node N3 and a potential of the second output node N4 based on a potential of the input node N2 under control of the potential of the first differential control node NC1 and a potential of the second differential control node NC2.

The input control circuit 33 is electrically connected to the output control terminal VCT, the input node N2 and a first voltage terminal V1, and is configured to control connection or disconnection between the input node N2 and the first voltage terminal V1 under control of the output control signal provided by the output control terminal VCT.

The output control circuit 34 is electrically connected to the output control terminal VCT, the first output node N3, the second output node N4 and the driving output terminal NT, and is configured to generate the driving output signal and provide the driving output signal via the driving output terminal NT based on the potential of the first output node N3 and the potential of the second output node N4 under control of the output control signal.

In at least one embodiment of the present disclosure, the output circuit further includes a second data writing circuit;
the second data writing circuit is electrically connected to the switch control terminal, a second data line and the second differential control node, and is configured to write a second data voltage provided by the second data line into the second differential control node and maintain the potential of the second differential control node under control of the switch control signal provided by the switch control terminal.

In a specific implementation, the output circuit may further include the second data writing circuit, and the second data writing circuit writes the second data voltage into the second differential control node and maintain the potential of the second differential control node under control of the switch control signal.

As shown in FIG. 5, based on at least one embodiment of the driving circuit shown in FIG. 1, the output circuit includes a first data writing circuit 31, a differential control circuit 32, an input control circuit 33, an output control circuit 34 and a second data writing circuit 35.

The first data writing circuit 31 is electrically connected to the switch control terminal SW, a first data line SL1 and a first differential control node NC1, and is configured to write a first data voltage provided by the first data line SL1 into the first differential control node NC1 and maintain a potential of the first differential control node NC1 under control of the switch control signal provided by the switch control terminal SW.

The second data writing circuit 35 is electrically connected to the switch control terminal SW, a second data line SL2 and the second differential control node NC2, and is configured to write a second data voltage provided by the second data line SL2 into the second differential control node NC2 and maintain the potential of the second differential control node NC2 under control of the switch control signal provided by the switch control terminal SW.

The differential control circuit 32 is electrically connected to the first differential control node NC1, a second differential control node NC2, an input node N2, a first output node N3 and a second output node N4, and is configured to control a potential of the first output node N3 and a potential of the second output node N4 based on a potential of the input node N2 under control of the potential of the first differential control node NC1 and a potential of the second differential control node NC2.

The input control circuit 33 is electrically connected to the output control terminal VCT, the input node N2 and a first voltage terminal V1, and is configured to control connection or disconnection between the input node N2 and the first voltage terminal V1 under control of the output control signal provided by the output control terminal VCT.

The output control circuit 34 is electrically connected to the output control terminal VCT, the first output node N3, the second output node N4 and the driving output terminal NT, and is configured to generate the driving output signal and provide the driving output signal via the driving output terminal NT based on the potential of the first output node N3 and the potential of the second output node N4 under control of the output control signal.

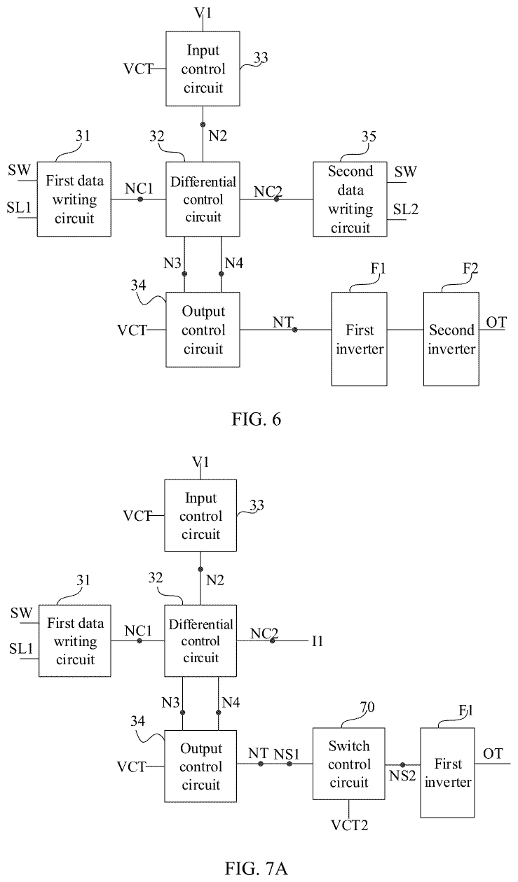

As shown in FIG. 6, based on at least one embodiment of the driving circuit shown in FIG. 2, the output circuit includes a first data writing circuit 31, a differential control circuit 32, an input control circuit 33, an output control circuit 34 and a second data writing circuit 35.

The first data writing circuit 31 is electrically connected to the switch control terminal SW, a first data line SL1 and a first differential control node NC1, and is configured to write a first data voltage provided by the first data line SL1 into the first differential control node NC1 and maintain a potential of the first differential control node NC1 under control of the switch control signal provided by the switch control terminal SW.

The second data writing circuit 35 is electrically connected to the switch control terminal SW, a second data line SL2 and the second differential control node NC2, and is configured to write a second data voltage provided by the second data line SL2 into the second differential control node NC2 and maintain the potential of the second differential control node NC2 under control of the switch control signal provided by the switch control terminal SW.

The differential control circuit 32 is electrically connected to the first differential control node NC1, a second differential control node NC2, an input node N2, a first output node N3 and a second output node N4, and is configured to control a potential of the first output node N3 and a potential of the second output node N4 based on a potential of the input node N2 under control of the potential of the first differential control node NC1 and a potential of the second differential control node NC2.

The input control circuit 33 is electrically connected to the output control terminal VCT, the input node N2 and a first voltage terminal V1, and is configured to control connection or disconnection between the input node N2 and the first voltage terminal V1 under control of the output control signal provided by the output control terminal VCT.

The output control circuit 34 is electrically connected to the output control terminal VCT, the first output node N3, the second output node N4 and the driving output terminal NT, and is configured to generate the driving output signal and provide the driving output signal via the driving output terminal NT based on the potential of the first output node N3 and the potential of the second output node N4 under control of the output control signal.

The driving circuit in at least one embodiment of the present disclosure further includes a switch control circuit;
the switch control circuit is electrically connected to an on-off control terminal, a first output control node and a second output control node, and is configured to control connection or disconnection between the first output control node and the second output control node under control of an on-off control signal provided by the on-off control terminal;
the first output control node is electrically connected to the driving output terminal, and the second output control node is electrically connected to the input terminal of the first inverter; or,
the first output control node is electrically connected to the output terminal of the N-th inverter, and the second output control node is electrically connected to the driving signal output terminal; or,
N is greater than 1, the first output control node is electrically connected to the output terminal of the m-th inverter, and the second output control node is electrically connected to the input terminal of the (m+1)-th inverter.

In a specific implementation, the driving circuit may further include the switch control circuit, and the switch control circuit controls connection or disconnection between the first output control node and the second output control node under control of the on-off control signal.

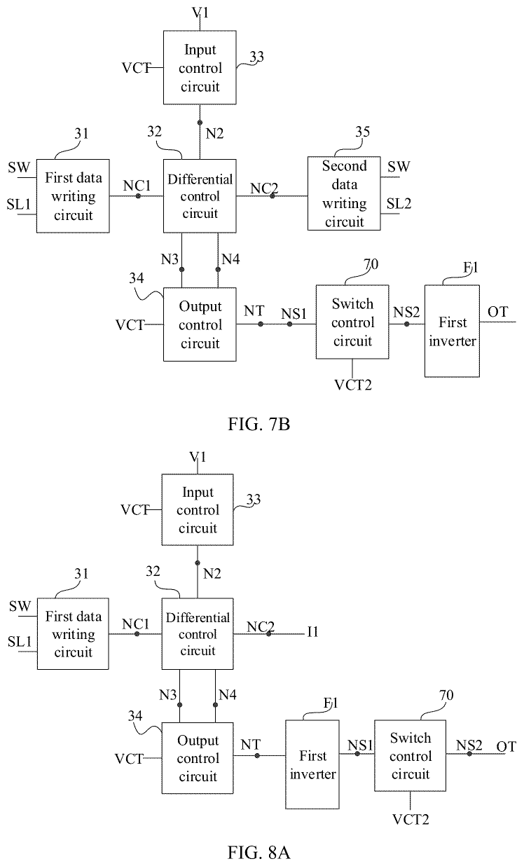

As shown in FIG. 7A, based on at least one embodiment of the driving circuit shown in FIG. 3, the driving circuit according to at least one embodiment of the present disclosure further includes a switch control circuit 70.

The switch control circuit 70 is electrically connected to an on-off control terminal VCT2, the driving output terminal NT and the input terminal of the first inverter F1, and is configured to control connection or disconnection between the driving output terminal NT and the input terminal of the first inverter F1 under control of an on-off control signal provided by the on-off control terminal VCT2.

In at least one embodiment of the driving circuit shown in FIG. 7A, reference sign NS1 denotes the first output control node, and reference sign NS2 denotes the second output control node.

NS1 is electrically connected to NT, and NS2 is electrically connected to the input terminal of the first inverter F1.

As shown in FIG. 7B, based on at least one embodiment of the driving circuit shown in FIG. 5, the driving circuit according to at least one embodiment of the present disclosure further includes a switch control circuit 70.

The switch control circuit 70 is electrically connected to an on-off control terminal VCT2, the driving output terminal NT and the input terminal of the first inverter F1, and is configured to control connection or disconnection between the driving output terminal NT and the input terminal of the first inverter F1 under control of an on-off control signal provided by the on-off control terminal VCT2.

In at least one embodiment of the driving circuit shown in FIG. 7B, reference sign NS1 denotes the first output control node, and reference sign NS2 denotes the second output control node.

NS1 is electrically connected to NT, and NS2 is electrically connected to the input terminal of the first inverter F1.

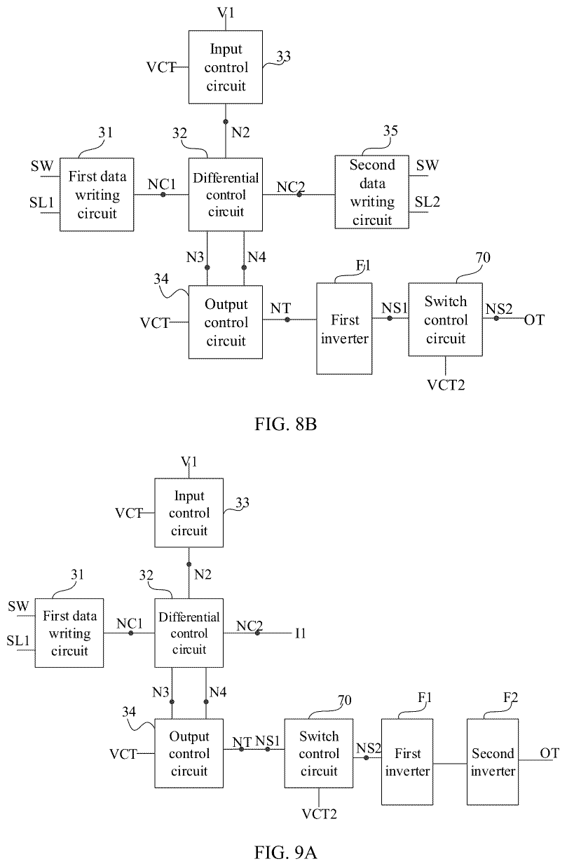

As shown in FIG. 8A, based on at least one embodiment of the driving circuit shown in FIG. 3, the driving circuit according to at least one embodiment of the present disclosure further includes a switch control circuit 70.

The switch control circuit 70 is electrically connected to an on-off control terminal VCT2, the output terminal of the first inverter F1 and the driving signal output terminal OT, and is configured to control connection or disconnection between the output terminal of the first inverter F1 and the driving signal output terminal OT under control of an on-off control signal provided by the on-off control terminal VCT2.

In at least one embodiment of the driving circuit shown in FIG. 8A, reference sign NS1 denotes the first output control node, and reference sign NS2 denotes the second output control node.

NS1 is electrically connected to the output terminal of the first inverter F1, and NS2 is electrically connected to the driving signal output terminal OT.

As shown in FIG. 8B, based on at least one embodiment of the driving circuit shown in FIG. 5, the driving circuit according to at least one embodiment of the present disclosure further includes a switch control circuit 70.

The switch control circuit 70 is electrically connected to an on-off control terminal VCT2, the output terminal of the first inverter F1 and the driving signal output terminal OT, and is configured to control connection or disconnection between the output terminal of the first inverter F1 and the driving signal output terminal OT under control of an on-off control signal provided by the on-off control terminal VCT2.

In at least one embodiment of the driving circuit shown in FIG. 8B, reference sign NS1 denotes the first output control node, and reference sign NS2 denotes the second output control node.

NS1 is electrically connected to the output terminal of the first inverter F1, and NS2 is electrically connected to the driving signal output terminal OT.

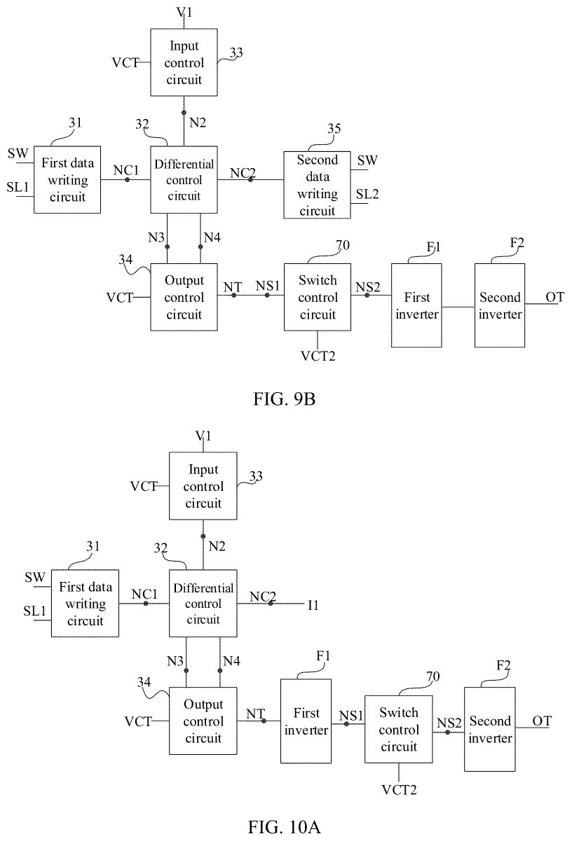

As shown in FIG. 9A, based on at least one embodiment of the driving circuit shown in FIG. 4, the driving circuit according to at least one embodiment of the present disclosure further includes a switch control circuit 70.

The switch control circuit 70 is electrically connected to an on-off control terminal VCT2, the driving output terminal NT and the input terminal of the first inverter F1, and is configured to control connection or disconnection between the driving output terminal NT and the input terminal of the first inverter F1 under control of an on-off control signal provided by the on-off control terminal VCT2.

In at least one embodiment of the driving circuit shown in FIG. 9A, reference sign NS1 denotes the first output control node, and reference sign NS2 denotes the second output control node.

NS1 is electrically connected to the driving output terminal NT, and NS2 is electrically connected to the input terminal of the first inverter F1.

As shown in FIG. 9B, based on at least one embodiment of the driving circuit shown in FIG. 6, the driving circuit according to at least one embodiment of the present disclosure further includes a switch control circuit 70.

The switch control circuit 70 is electrically connected to an on-off control terminal VCT2, the driving output terminal NT and the input terminal of the first inverter F1, and is configured to control connection or disconnection between the driving output terminal NT and the input terminal of the first inverter F1 under control of an on-off control signal provided by the on-off control terminal VCT2.

In at least one embodiment of the driving circuit shown in FIG. 9B, reference sign NS1 denotes the first output control node, and reference sign NS2 denotes the second output control node.

NS1 is electrically connected to the driving output terminal NT, and NS2 is electrically connected to the input terminal of the first inverter F1.

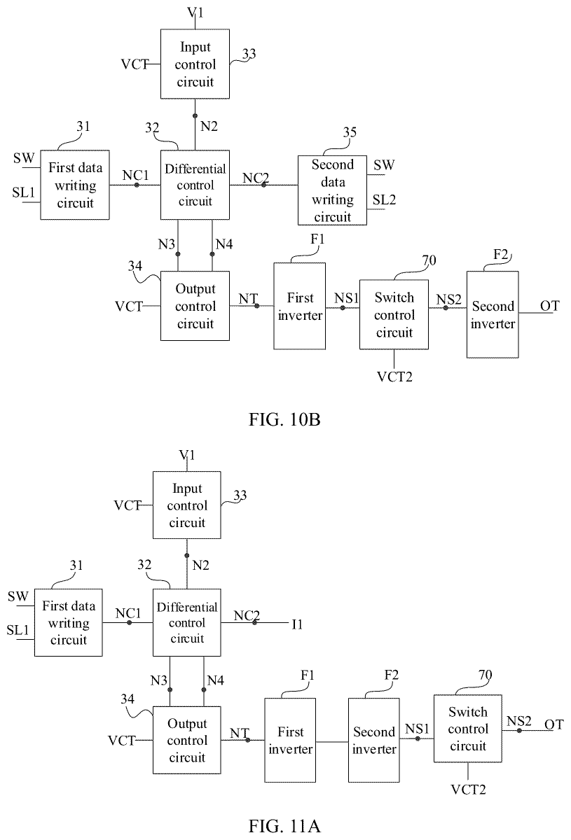

As shown in FIG. 10A, based on at least one embodiment of the driving circuit shown in FIG. 4, the driving circuit according to at least one embodiment of the present disclosure further includes a switch control circuit 70.

The switch control circuit 70 is electrically connected to an on-off control terminal VCT2, the output terminal of the first inverter F1 and the input terminal of the second inverter F2, and is configured to control connection or disconnection between the output terminal of the first inverter F1 and the input terminal of the second inverter F2 under control of an on-off control signal provided by the on-off control terminal VCT2.

In at least one embodiment of the driving circuit shown in FIG. 10A, reference sign NS1 denotes the first output control node, and reference sign NS2 denotes the second output control node.

NS1 is electrically connected to the output terminal of the first inverter F1, and NS2 is electrically connected to the input terminal of the second inverter F2.

As shown in FIG. 10B, based on at least one embodiment of the driving circuit shown in FIG. 6, the driving circuit according to at least one embodiment of the present disclosure further includes a switch control circuit 70.

The switch control circuit 70 is electrically connected to an on-off control terminal VCT2, the output terminal of the first inverter F1 and the input terminal of the second inverter F2, and is configured to control connection or disconnection between the output terminal of the first inverter F1 and the input terminal of the second inverter F2 under control of an on-off control signal provided by the on-off control terminal VCT2.

In at least one embodiment of the driving circuit shown in FIG. 10B, reference sign NS1 denotes the first output control node, and reference sign NS2 denotes the second output control node.

NS1 is electrically connected to the output terminal of the first inverter F1, and NS2 is electrically connected to the input terminal of the second inverter F2.

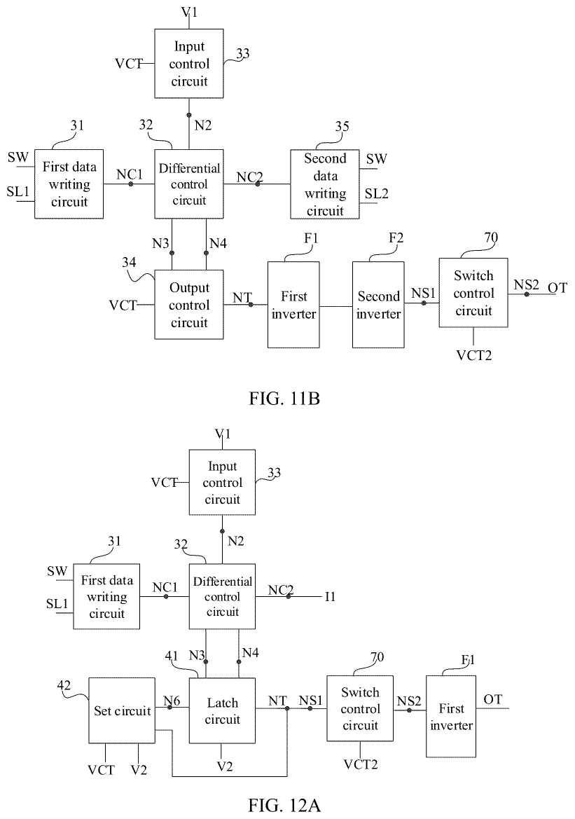

As shown in FIG. 11A, based on at least one embodiment of the driving circuit shown in FIG. 4, the driving circuit according to at least one embodiment of the present disclosure further includes a switch control circuit 70.

The switch control circuit 70 is electrically connected to an on-off control terminal VCT2, the output terminal of the second inverter F2 and the driving signal output terminal OT, and is configured to control connection or disconnection between the output terminal of the second inverter F2 and the driving signal output terminal OT under control of an on-off control signal provided by the on-off control terminal VCT2.

In at least one embodiment of the driving circuit shown in FIG. 11A, reference sign NS1 denotes the first output control node, and reference sign NS2 denotes the second output control node.

NS1 is electrically connected to the output terminal of the second inverter F2, and NS2 is electrically connected to the driving signal output terminal OT.

As shown in FIG. 11B, based on at least one embodiment of the driving circuit shown in FIG. 6, the driving circuit according to at least one embodiment of the present disclosure further includes a switch control circuit 70.

The switch control circuit 70 is electrically connected to an on-off control terminal VCT2, the output terminal of the second inverter F2 and the driving signal output terminal OT, and is configured to control connection or disconnection between the output terminal of the second inverter F2 and the driving signal output terminal OT under control of an on-off control signal provided by the on-off control terminal VCT2.

In at least one embodiment of the driving circuit shown in FIG. 11B, reference sign NS1 denotes the first output control node, and reference sign NS2 denotes the second output control node.

NS1 is electrically connected to the output terminal of the second inverter F2, and NS2 is electrically connected to the driving signal output terminal OT.

In at least one embodiment of the present disclosure, the output control circuit includes a latch circuit and a set circuit;
the set circuit is electrically connected to the output control terminal, an intermediate node, the driving output terminal and a second voltage terminal, and is configured to control connection or disconnection between the intermediate node and the second voltage terminal and control connection or disconnection between the driving output terminal and the second voltage terminal under control of the output control signal; and
the latch circuit is electrically connected to the first output node, the second output node, the intermediate node, the driving output terminal and the second voltage terminal, and is configured to control a potential of the driving output terminal based on the potential of the first output node and the potential of the second output node under control of a potential of the intermediate node.

In a specific implementation, the output control circuit may include the latch circuit and the set circuit. The set circuit controls connection or disconnection between the intermediate node and the second voltage terminal and controls connection or disconnection between the driving output terminal and the second voltage terminal under control of the output control signal; the latch circuit controls the potential of the driving output terminal based on the potential of the first output node and the potential of the second output node under control of the potential of the intermediate node.

In at least one embodiment of the present disclosure, the latch circuit is configured to control connection or disconnection between the second output node and the driving output terminal and connection or disconnection between the driving output terminal and the second voltage terminal under control of the potential of the intermediate node, and to control connection or disconnection between the first output node and the intermediate node and connection or disconnection between the intermediate node and the second voltage terminal under control of the potential of the driving output terminal.

Optionally, the second voltage terminal may be a low voltage terminal.

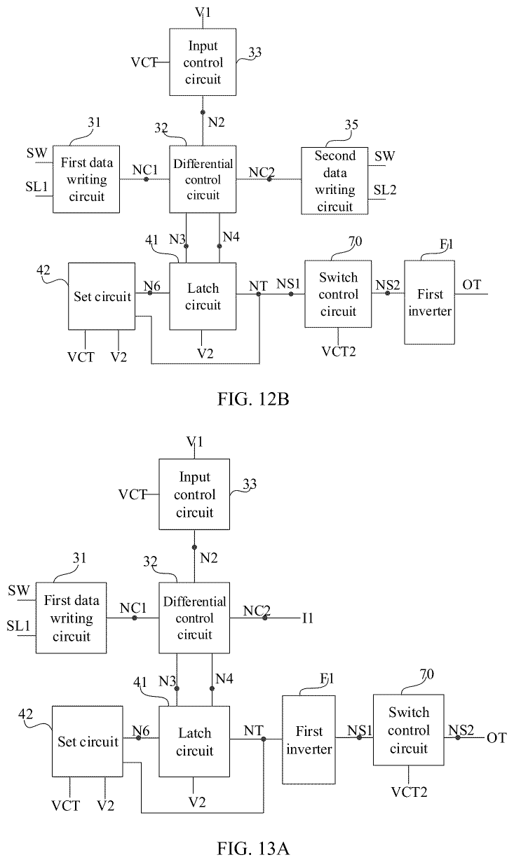

As shown in FIG. 12A, based on at least one embodiment of the driving circuit shown in FIG. 7A, in at least one embodiment of the present disclosure, the output control circuit includes a latch circuit 41 and a set circuit 42.

The set circuit 42 is electrically connected to the output control terminal VCT, the intermediate node N6, the driving output terminal NT and the second voltage terminal V2, and is configured to control connection or disconnection between the intermediate node N6 and the second voltage terminal V2 and control connection or disconnection between the driving output terminal NT and the second voltage terminal V2 under control of the output control signal.

The latch circuit 41 is electrically connected to the first output node N3, the second output node N4, the intermediate node N6, the driving output terminal NT and the second voltage terminal V2, and is configured to control a potential of the driving output terminal NT based on the potential of the first output node N3 and the potential of the second output node N4 under control of a potential of the intermediate node N6.

In at least one embodiment of the driving circuit shown in FIG. 12A, reference sign NS1 denotes the first output control node, and reference sign NS2 denotes the second output control node.

NS1 is electrically connected to the driving output terminal NT, and NS2 is electrically connected to the input terminal of the first inverter F1.

As shown in FIG. 12B, based on at least one embodiment of the driving circuit shown in FIG. 7B, in at least one embodiment of the present disclosure, the output control circuit includes a latch circuit 41 and a set circuit 42.

The set circuit 42 is electrically connected to the output control terminal VCT, the intermediate node N6, the driving output terminal NT and the second voltage terminal V2, and is configured to control connection or disconnection between the intermediate node N6 and the second voltage terminal V2 and control connection or disconnection between the driving output terminal NT and the second voltage terminal V2 under control of the output control signal.

The latch circuit 41 is electrically connected to the first output node N3, the second output node N4, the intermediate node N6, the driving output terminal NT and the second voltage terminal V2, and is configured to control a potential of the driving output terminal NT based on the potential of the first output node N3 and the potential of the second output node N4 under control of a potential of the intermediate node N6.

In at least one embodiment of the driving circuit shown in FIG. 12B, reference sign NS1 denotes the first output control node, and reference sign NS2 denotes the second output control node.

NST is electrically connected to the driving output terminal NT, and NS2 is electrically connected to the input terminal of the first inverter F1.

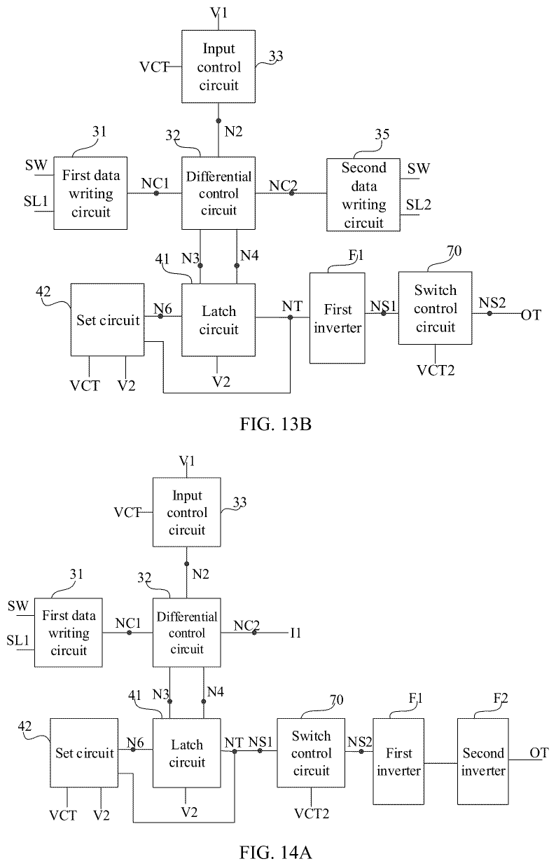

As shown in FIG. 13A, based on at least one embodiment of the driving circuit shown in FIG. 8A, in at least one embodiment of the present disclosure, the output control circuit includes a latch circuit 41 and a set circuit 42.

The set circuit 42 is electrically connected to the output control terminal VCT, the intermediate node N6, the driving output terminal NT and the second voltage terminal V2, and is configured to control connection or disconnection between the intermediate node N6 and the second voltage terminal V2 and control connection or disconnection between the driving output terminal NT and the second voltage terminal V2 under control of the output control signal.

The latch circuit 41 is electrically connected to the first output node N3, the second output node N4, the intermediate node N6, the driving output terminal NT and the second voltage terminal V2, and is configured to control a potential of the driving output terminal NT based on the potential of the first output node N3 and the potential of the second output node N4 under control of a potential of the intermediate node N6.

In at least one embodiment of the driving circuit shown in FIG. 13A, reference sign NS1 denotes the first output control node, and reference sign NS2 denotes the second output control node.

NS1 is electrically connected to the output terminal of the first inverter F1, and NS2 is electrically connected to the driving signal output terminal OT.

As shown in FIG. 13B, based on at least one embodiment of the driving circuit shown in FIG. 8B, in at least one embodiment of the present disclosure, the output control circuit includes a latch circuit 41 and a set circuit 42.

The set circuit 42 is electrically connected to the output control terminal VCT, the intermediate node N6, the driving output terminal NT and the second voltage terminal V2, and is configured to control connection or disconnection between the intermediate node N6 and the second voltage terminal V2 and control connection or disconnection between the driving output terminal NT and the second voltage terminal V2 under control of the output control signal.

The latch circuit 41 is electrically connected to the first output node N3, the second output node N4, the intermediate node N6, the driving output terminal NT and the second voltage terminal V2, and is configured to control a potential of the driving output terminal NT based on the potential of the first output node N3 and the potential of the second output node N4 under control of a potential of the intermediate node N6.

In at least one embodiment of the driving circuit shown in FIG. 13B, reference sign NS1 denotes the first output control node, and reference sign NS2 denotes the second output control node.

NS1 is electrically connected to the output terminal of the first inverter F1, and NS2 is electrically connected to the driving signal output terminal OT.

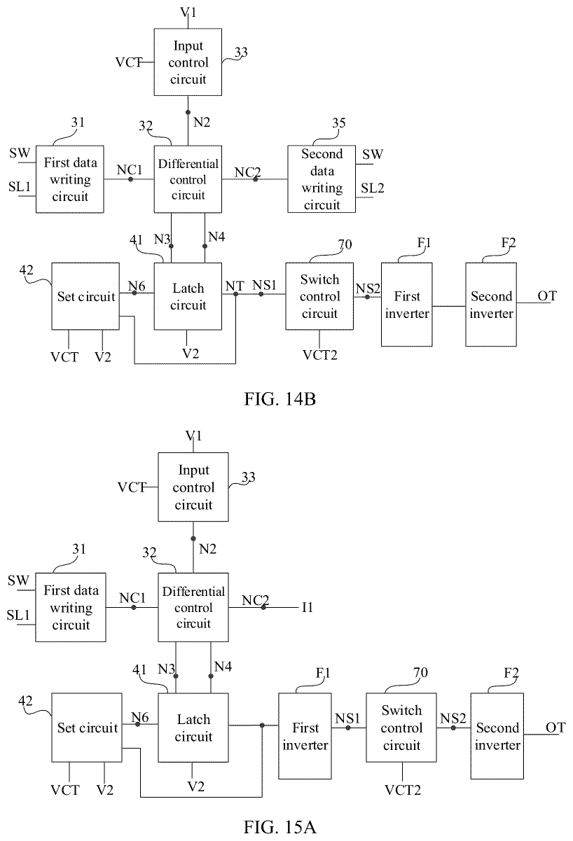

As shown in FIG. 14A, based on at least one embodiment of the driving circuit shown in FIG. 9A, in at least one embodiment of the present disclosure, the output control circuit includes a latch circuit 41 and a set circuit 42.

The set circuit 42 is electrically connected to the output control terminal VCT, the intermediate node N6, the driving output terminal NT and the second voltage terminal V2, and is configured to control connection or disconnection between the intermediate node N6 and the second voltage terminal V2 and control connection or disconnection between the driving output terminal NT and the second voltage terminal V2 under control of the output control signal.

The latch circuit 41 is electrically connected to the first output node N3, the second output node N4, the intermediate node N6, the driving output terminal NT and the second voltage terminal V2, and is configured to control a potential of the driving output terminal NT based on the potential of the first output node N3 and the potential of the second output node N4 under control of a potential of the intermediate node N6.

In at least one embodiment of the driving circuit shown in FIG. 14A, reference sign NST denotes the first output control node, and reference sign NS2 denotes the second output control node.

NS1 is electrically connected to the driving output terminal NT, and NS2 is electrically connected to the input terminal of the first inverter F1.

As shown in FIG. 14B, based on at least one embodiment of the driving circuit shown in FIG. 9B, in at least one embodiment of the present disclosure, the output control circuit includes a latch circuit 41 and a set circuit 42.

The set circuit 42 is electrically connected to the output control terminal VCT, the intermediate node N6, the driving output terminal NT and the second voltage terminal V2, and is configured to control connection or disconnection between the intermediate node N6 and the second voltage terminal V2 and control connection or disconnection between the driving output terminal NT and the second voltage terminal V2 under control of the output control signal.

The latch circuit 41 is electrically connected to the first output node N3, the second output node N4, the intermediate node N6, the driving output terminal NT and the second voltage terminal V2, and is configured to control a potential of the driving output terminal NT based on the potential of the first output node N3 and the potential of the second output node N4 under control of a potential of the intermediate node N6.

In at least one embodiment of the driving circuit shown in FIG. 14B, reference sign NS1 denotes the first output control node, and reference sign NS2 denotes the second output control node.

NS1 is electrically connected to the driving output terminal NT, and NS2 is electrically connected to the input terminal of the first inverter F1.

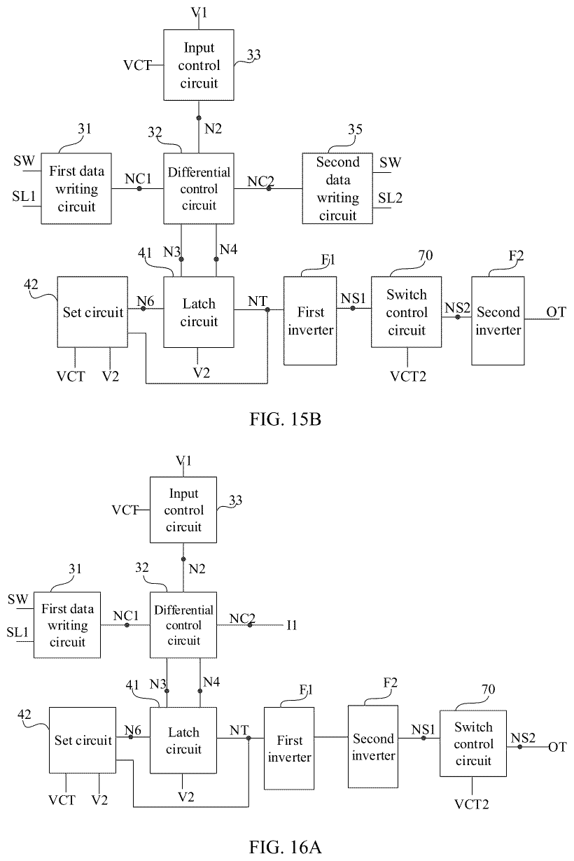

As shown in FIG. 15A, based on at least one embodiment of the driving circuit shown in FIG. 10A, in at least one embodiment of the present disclosure, the output control circuit includes a latch circuit 41 and a set circuit 42.

The set circuit 42 is electrically connected to the output control terminal VCT, the intermediate node N6, the driving output terminal NT and the second voltage terminal V2, and is configured to control connection or disconnection between the intermediate node N6 and the second voltage terminal V2 and control connection or disconnection between the driving output terminal NT and the second voltage terminal V2 under control of the output control signal.

The latch circuit 41 is electrically connected to the first output node N3, the second output node N4, the intermediate node N6, the driving output terminal NT and the second voltage terminal V2, and is configured to control a potential of the driving output terminal NT based on the potential of the first output node N3 and the potential of the second output node N4 under control of a potential of the intermediate node N6.

In at least one embodiment of the driving circuit shown in FIG. 15A, reference sign NS1 denotes the first output control node, and reference sign NS2 denotes the second output control node.

NS1 is electrically connected to the output terminal of the first inverter F1, and NS2 is electrically connected to the input terminal of the second inverter F2.

As shown in FIG. 15B, based on at least one embodiment of the driving circuit shown in FIG. 10B, in at least one embodiment of the present disclosure, the output control circuit includes a latch circuit 41 and a set circuit 42.

The set circuit 42 is electrically connected to the output control terminal VCT, the intermediate node N6, the driving output terminal NT and the second voltage terminal V2, and is configured to control connection or disconnection between the intermediate node N6 and the second voltage terminal V2 and control connection or disconnection between the driving output terminal NT and the second voltage terminal V2 under control of the output control signal.

The latch circuit 41 is electrically connected to the first output node N3, the second output node N4, the intermediate node N6, the driving output terminal NT and the second voltage terminal V2, and is configured to control a potential of the driving output terminal NT based on the potential of the first output node N3 and the potential of the second output node N4 under control of a potential of the intermediate node N6.

In at least one embodiment of the driving circuit shown in FIG. 15B, reference sign NS1 denotes the first output control node, and reference sign NS2 denotes the second output control node.

NS1 is electrically connected to the output terminal of the first inverter F1, and NS2 is electrically connected to the input terminal of the second inverter F2.

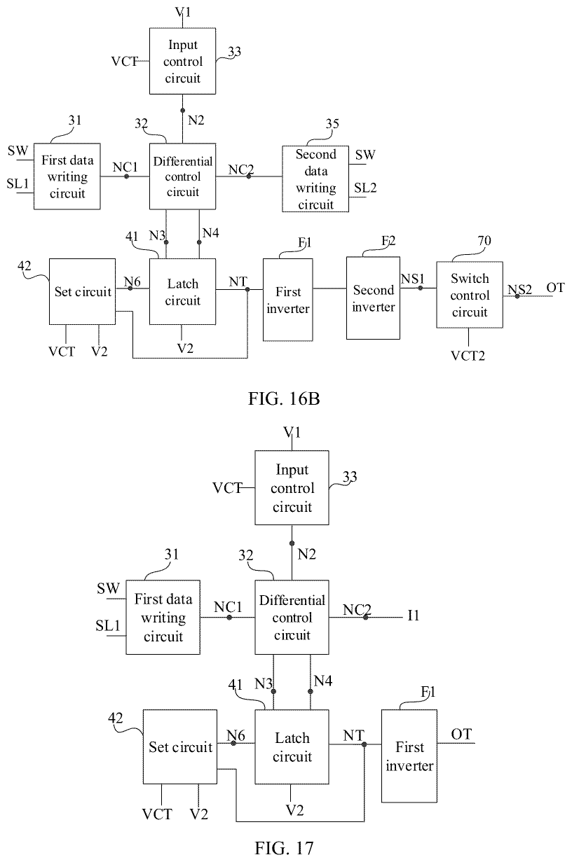

As shown in FIG. 16A, based on at least one embodiment of the driving circuit shown in FIG. 11A, in at least one embodiment of the present disclosure, the output control circuit includes a latch circuit 41 and a set circuit 42.

The set circuit 42 is electrically connected to the output control terminal VCT, the intermediate node N6, the driving output terminal NT and the second voltage terminal V2, and is configured to control connection or disconnection between the intermediate node N6 and the second voltage terminal V2 and control connection or disconnection between the driving output terminal NT and the second voltage terminal V2 under control of the output control signal.

The latch circuit 41 is electrically connected to the first output node N3, the second output node N4, the intermediate node N6, the driving output terminal NT and the second voltage terminal V2, and is configured to control a potential of the driving output terminal NT based on the potential of the first output node N3 and the potential of the second output node N4 under control of a potential of the intermediate node N6.

In at least one embodiment of the driving circuit shown in FIG. 16A, reference sign NS1 denotes the first output control node, and reference sign NS2 denotes the second output control node.

NS1 is electrically connected to the output terminal of the second inverter F2, and NS2 is electrically connected to the driving signal output terminal OT.

As shown in FIG. 16B, based on at least one embodiment of the driving circuit shown in FIG. 11B, in at least one embodiment of the present disclosure, the output control circuit includes a latch circuit 41 and a set circuit 42.

The set circuit 42 is electrically connected to the output control terminal VCT, the intermediate node N6, the driving output terminal NT and the second voltage terminal V2, and is configured to control connection or disconnection between the intermediate node N6 and the second voltage terminal V2 and control connection or disconnection between the driving output terminal NT and the second voltage terminal V2 under control of the output control signal.

The latch circuit 41 is electrically connected to the first output node N3, the second output node N4, the intermediate node N6, the driving output terminal NT and the second voltage terminal V2, and is configured to control a potential of the driving output terminal NT based on the potential of the first output node N3 and the potential of the second output node N4 under control of a potential of the intermediate node N6.

In at least one embodiment of the driving circuit shown in FIG. 16B, reference sign NS1 denotes the first output control node, and reference sign NS2 denotes the second output control node.

NS1 is electrically connected to the output terminal of the second inverter F2, and NS2 is electrically connected to the driving signal output terminal OT.

In at least one embodiment of the present disclosure, a frame time includes a blanking period, the blanking period includes an off phase, and the off phase includes a setting period;
the set circuit is configured to control connection between the intermediate node and the second voltage terminal and control connection between the driving output terminal and the second voltage terminal under control of the output control signal during the setting period; and
the switch control circuit is configured to control disconnection between the first output control node and the second output control node under control of the on-off control signal during the off phase.

In a specific implementation, the frame time includes the blanking period, the blanking period includes the off phase, the off phase includes the setting period; in the setting period, the set circuit controls connection between the intermediate node and the second voltage terminal and controls connection between the driving output terminal and the second voltage terminal under control of the output control signal; and in the off phase, the switch control circuit controls disconnection between the first output control node and the second output control node under control of the on-off control signal. In this way, in the blanking period, the driving signal provided by the driving signal output terminal is not affected by the rising edge and the falling edge of the driving output signal provided by the driving output terminal.

As shown in FIG. 17, based on at least one embodiment of the driving circuit shown in FIG. 3, in at least one embodiment of the present disclosure, the output control circuit includes a latch circuit 41 and a set circuit 42.

The set circuit 42 is electrically connected to the output control terminal VCT, the intermediate node N6, the driving output terminal NT and the second voltage terminal V2, and is configured to control connection or disconnection between the intermediate node N6 and the second voltage terminal V2 and control connection or disconnection between the driving output terminal NT and the second voltage terminal V2 under control of the output control signal.

The latch circuit 41 is electrically connected to the first output node N3, the second output node N4, the intermediate node N6, the driving output terminal NT and the second voltage terminal V2, and is configured to control a potential of the driving output terminal NT based on the potential of the first output node N3 and the potential of the second output node N4 under control of a potential of the intermediate node N6.

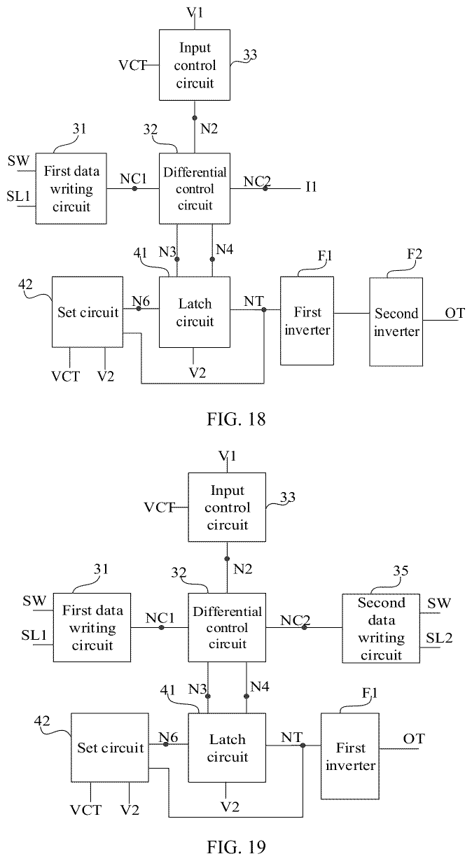

As shown in FIG. 18, based on at least one embodiment of the driving circuit shown in FIG. 4, in at least one embodiment of the present disclosure, the output control circuit includes a latch circuit 41 and a set circuit 42.

The set circuit 42 is electrically connected to the output control terminal VCT, the intermediate node N6, the driving output terminal NT and the second voltage terminal V2, and is configured to control connection or disconnection between the intermediate node N6 and the second voltage terminal V2 and control connection or disconnection between the driving output terminal NT and the second voltage terminal V2 under control of the output control signal.

The latch circuit 41 is electrically connected to the first output node N3, the second output node N4, the intermediate node N6, the driving output terminal NT and the second voltage terminal V2, and is configured to control a potential of the driving output terminal NT based on the potential of the first output node N3 and the potential of the second output node N4 under control of a potential of the intermediate node N6.

As shown in FIG. 19, based on at least one embodiment of the driving circuit shown in FIG. 5, in at least one embodiment of the present disclosure, the output control circuit includes a latch circuit 41 and a set circuit 42.

The set circuit 42 is electrically connected to the output control terminal VCT, the intermediate node N6, the driving output terminal NT and the second voltage terminal V2, and is configured to control connection or disconnection between the intermediate node N6 and the second voltage terminal V2 and control connection or disconnection between the driving output terminal NT and the second voltage terminal V2 under control of the output control signal.

The latch circuit 41 is electrically connected to the first output node N3, the second output node N4, the intermediate node N6, the driving output terminal NT and the second voltage terminal V2, and is configured to control a potential of the driving output terminal NT based on the potential of the first output node N3 and the potential of the second output node N4 under control of a potential of the intermediate node N6.

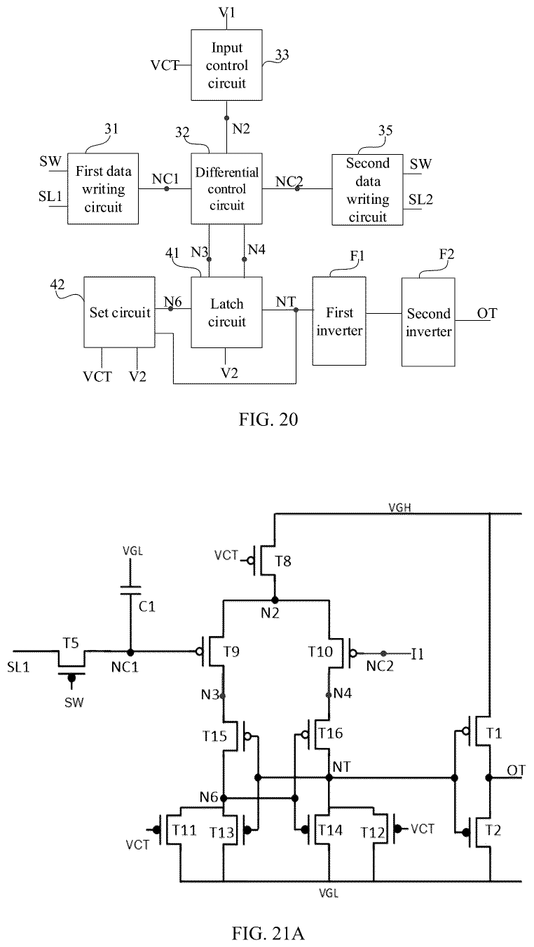

As shown in FIG. 20, based on at least one embodiment of the driving circuit shown in FIG. 6, in at least one embodiment of the present disclosure, the output control circuit includes a latch circuit 41 and a set circuit 42.

The set circuit 42 is electrically connected to the output control terminal VCT, the intermediate node N6, the driving output terminal NT and the second voltage terminal V2, and is configured to control connection or disconnection between the intermediate node N6 and the second voltage terminal V2 and control connection or disconnection between the driving output terminal NT and the second voltage terminal V2 under control of the output control signal.

The latch circuit 41 is electrically connected to the first output node N3, the second output node N4, the intermediate node N6, the driving output terminal NT and the second voltage terminal V2, and is configured to control a potential of the driving output terminal NT based on the potential of the first output node N3 and the potential of the second output node N4 under control of a potential of the intermediate node N6.

Optionally, N is equal to 1, the inverting circuit includes the first inverter, and the first inverter includes a first transistor and a second transistor;
a gate electrode of the first transistor is electrically connected to the input terminal of the first inverter, a first electrode of the first transistor is electrically connected to a first voltage terminal, and a second electrode of the first transistor and a first electrode of the second transistor are both electrically connected to the driving signal output terminal;
a gate electrode of the second transistor is electrically connected to the input terminal of the first inverter, and a second electrode of the second transistor is electrically connected to a second voltage terminal; and
the first transistor is a p-type transistor, and the second transistor is an n-type transistor.

Optionally, N is equal to 2, the inverting circuit includes the first inverter and a second inverter, the first inverter includes a first transistor and a second transistor, and the second inverter includes a third transistor and a fourth transistor;
a gate electrode of the first transistor is electrically connected to the input terminal of the first inverter, a first electrode of the first transistor is electrically connected to a first voltage terminal, and a second electrode of the first transistor and a first electrode of the second transistor are both electrically connected to an input terminal of the second inverter;
a gate electrode of the second transistor is electrically connected to the input terminal of the first inverter, and a second electrode of the second transistor is electrically connected to a second voltage terminal;
a gate electrode of the third transistor and a gate electrode of the fourth transistor are both electrically connected to the input terminal of the second inverter, a first electrode of the third transistor is electrically connected to the first voltage terminal, and a second electrode of the third transistor and a first electrode of the fourth transistor are both electrically connected to the driving signal output terminal;
a second electrode of the fourth transistor is electrically connected to the second voltage terminal; and
the first transistor is a p-type transistor, the second transistor is an n-type transistor; the third transistor is a p-type transistor, and the fourth transistor is an n-type transistor.
the first data writing circuit includes a fifth transistor and a first capacitor;
a gate electrode of the fifth transistor is electrically connected to the switch control terminal, a first electrode of the fifth transistor is electrically connected to the first data line, and a second electrode of the fifth transistor is electrically connected to the first differential control node; and
a first terminal of the first capacitor is electrically connected to the first differential control node, and a second terminal of the first capacitor is electrically connected to a second voltage terminal.

Optionally, the second data writing circuit includes a sixth transistor and a second capacitor, a gate electrode of the sixth transistor is electrically connected to the switch control terminal, a first electrode of the sixth transistor is electrically connected to the second data line, and a second electrode of the sixth transistor is electrically connected to the second differential control node; and
a first terminal of the second capacitor is electrically connected to the second differential control node, and a second terminal of the second capacitor is electrically connected to the second voltage terminal.

Optionally, the switch control circuit includes a seventh transistor;
a gate electrode of the seventh transistor is electrically connected to the on-off control terminal, a first electrode of the seventh transistor is electrically connected to the first output control node, and a second electrode of the seventh transistor is electrically connected to the second output control node.

In at least one embodiment of the present disclosure, the first output control node is electrically connected to the driving output terminal, and the second output control node is electrically connected to the input terminal of the first inverter; or,
the first output control node is electrically connected to the output terminal of the N-th inverter, and the second output control node is electrically connected to the driving signal output terminal; or,
N is greater than 1, the first output control node is electrically connected to the output terminal of the m-th inverter, and the second output control node is electrically connected to the input terminal of the (m+1)-th inverter.

Optionally, the input control circuit includes an eighth transistor, and the differential control circuit includes a ninth transistor and a tenth transistor;
a gate electrode of the eighth transistor is electrically connected to the output control terminal, a first electrode of the eighth transistor is electrically connected to the first voltage terminal, and a second electrode of the eighth transistor is electrically connected to the input node;
a gate electrode of the ninth transistor is electrically connected to the first differential control node, a first electrode of the ninth transistor is electrically connected to the input node, and a second electrode of the ninth transistor is electrically connected to the first output node; and
a gate electrode of the tenth transistor is electrically connected to the second differential control node, a first electrode of the tenth transistor is electrically connected to the input node, and a second electrode of the tenth transistor is electrically connected to the second output node.

Optionally, the set circuit includes an eleventh transistor and a twelfth transistor;
a gate electrode of the eleventh transistor is electrically connected to the output control terminal, a first electrode of the eleventh transistor is electrically connected to the intermediate node, and a second electrode of the eleventh transistor is electrically connected to the second voltage terminal; and
a gate electrode of the twelfth transistor is electrically connected to the output control terminal, a first electrode of the twelfth transistor is electrically connected to the driving output terminal, and a second electrode of the twelfth transistor is electrically connected to the second voltage terminal.

Optionally, the eighth transistor is a p-type transistor, and the eleventh transistor and the twelfth transistor are n-type transistors; or, the eighth transistor is an n-type transistor, and the eleventh transistor and the twelfth transistor are p-type transistors.

Optionally the latch circuit includes a thirteenth transistor, a fourteenth transistor, a fifteenth transistor, and a sixteenth transistor;
a gate electrode of the thirteenth transistor is electrically connected to the driving output terminal, a first electrode of the thirteenth transistor is electrically connected to the intermediate node, and a second electrode of the thirteenth transistor is electrically connected to the second voltage terminal;
a gate electrode of the fourteenth transistor is electrically connected to the intermediate node, a first electrode of the fourteenth transistor is electrically connected to the driving output terminal, and a second electrode of the fourteenth transistor is electrically connected to the second voltage terminal;
a gate electrode of the fifteenth transistor is electrically connected to the driving output terminal, a first electrode of the fifteenth transistor is electrically connected to the first output node, and a second electrode of the fifteenth transistor is electrically connected to the intermediate node; and
a gate electrode of the sixteenth transistor is electrically connected to the intermediate node, a first electrode of the sixteenth transistor is electrically connected to the second output node, and a second electrode of the sixteenth transistor is electrically connected to the driving output terminal.

Optionally, the thirteenth transistor and the fourteenth transistor are n-type transistors, and the fifteenth transistor and the sixteenth transistor are p-type transistors.

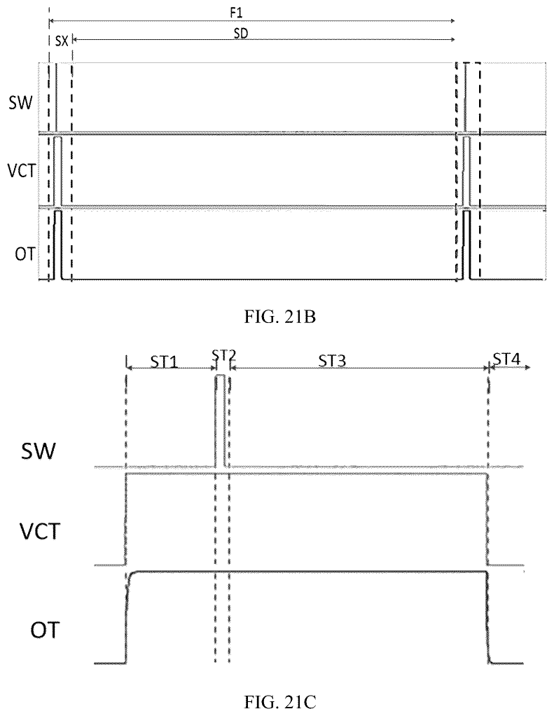

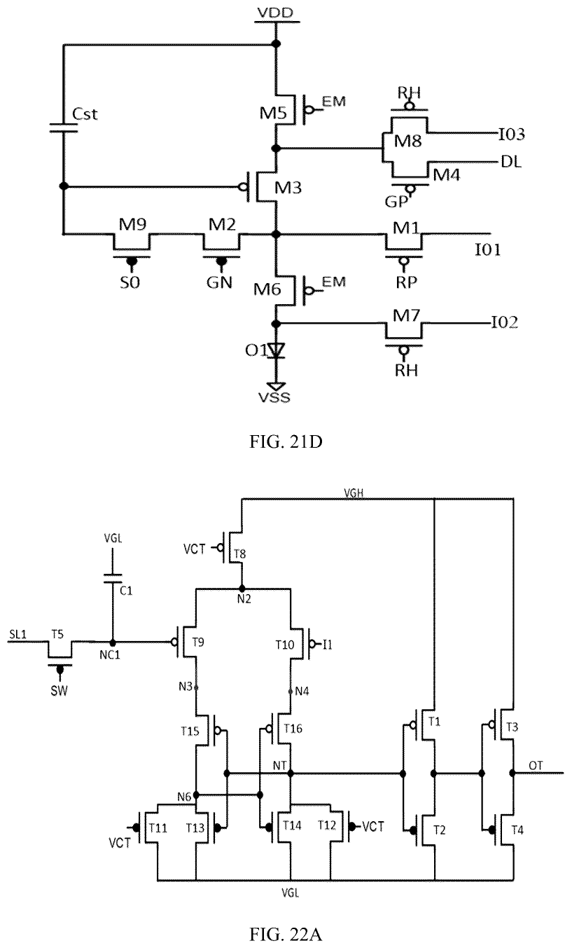

As shown in FIG. 21A, based on at least one embodiment of the pixel circuit shown in FIG. 17:

The first inverter includes a first transistor T1 and a second transistor T2.

A gate electrode of the first transistor T1 is electrically connected to the input terminal of the first inverter, a source electrode of the first transistor T1 is electrically connected to a high voltage terminal VGH, and a drain electrode of the first transistor T1 and a source electrode of the second transistor T2 are both electrically connected to the driving signal output terminal OT.

A gate electrode of the second transistor T2 is electrically connected to the input terminal of the first inverter, and a drain electrode of the second transistor T2 is electrically connected to the low voltage terminal VGL.

The input terminal of the first inverter is electrically connected to the driving output terminal NT.

The first transistor T1 is a p-type transistor, and the second transistor T2 is an n-type transistor.

The first data writing circuit includes a fifth transistor T5 and a first capacitor C1.

A gate electrode of the fifth transistor T5 is electrically connected to the switch control terminal SW, a source electrode of the fifth transistor T5 is electrically connected to the first data line SL1, and a drain electrode of the fifth transistor T5 is electrically connected to the first differential control node NC1.

A first terminal of the first capacitor C1 is electrically connected to the first differential control node NC1, and a second terminal of the first capacitor C1 is electrically connected to the low voltage terminal VGL.

The input control circuit includes an eighth transistor T8, and the differential control circuit includes a ninth transistor T9 and a tenth transistor T10.

A gate electrode of the eighth transistor T8 is electrically connected to the output control terminal VCT, a source electrode of the eighth transistor T8 is electrically connected to the high voltage terminal VGH, and a drain electrode of the eighth transistor T8 is electrically connected to the input node N2.

A gate electrode of the ninth transistor T9 is electrically connected to the first differential control node NCT, a source electrode of the ninth transistor T9 is electrically connected to the input node N2, and a drain electrode of the ninth transistor T9 is electrically connected to the first output node N3.

A gate electrode of the tenth transistor T10 is electrically connected to the second differential control node NC2, a source electrode of the tenth transistor T10 is electrically connected to the input node N2, and a drain electrode of the tenth transistor T10 is electrically connected to the second output node N4; the second differential control node NC2 is electrically connected to an initial voltage terminal I1.

The set circuit includes an eleventh transistor T11 and a twelfth transistor T12.

A gate electrode of the eleventh transistor T11 is electrically connected to the output control terminal VCT, a source electrode of the eleventh transistor T11 is electrically connected to the intermediate node N6, and a source electrode of the eleventh transistor T11 is electrically connected to the low voltage terminal VGL.

A gate electrode of the twelfth transistor T12 is electrically connected to the output control terminal VCT, a source electrode of the twelfth transistor T12 is electrically connected to the driving output terminal NT, and a drain electrode of the twelfth transistor T12 is electrically connected to the low voltage terminal VGL.

The eighth transistor T8 is a p-type transistor, and the eleventh transistor T11 and the twelfth transistor T12 are n-type transistors.

The latch circuit includes a thirteenth transistor T13, a fourteenth transistor T14, a fifteenth transistor T15 and a sixteenth transistor T16.

A gate electrode of the thirteenth transistor T13 is electrically connected to the driving output terminal NT, a source electrode of the thirteenth transistor T13 is electrically connected to the intermediate node N6, and a drain electrode of the thirteenth transistor T13 is electrically connected to the low voltage terminal VGL.

Agate electrode of the fourteenth transistor T14 is electrically connected to the intermediate node N6, a source electrode of the fourteenth transistor T14 is electrically connected to the driving output terminal NT, and a drain electrode of the fourteenth transistor T14 is electrically connected to the low voltage terminal VGL.

A gate electrode of the fifteenth transistor T15 is electrically connected to the driving output terminal NT, a source electrode of the fifteenth transistor T15 is electrically connected to the first output node N3, and a drain electrode of the fifteenth transistor T15 is electrically connected to the intermediate node N6.

A gate electrode of the sixteenth transistor T16 is electrically connected to the intermediate node N6, a source electrode of the sixteenth transistor T16 is electrically connected to the second output node N4, and a drain electrode of the sixteenth transistor T16 is electrically connected to the driving output terminal NT.

The thirteenth transistor T13 and the fourteenth transistor T14 are n-type transistors, and the fifteenth transistor T15 and the sixteenth transistor T16 are p-type transistors.

In at least one embodiment of the present disclosure, the second voltage terminal may be a low voltage terminal, which is not limited thereto.

In at least one embodiment of the driving circuit shown in FIG. 21A, T1, T8, T9, T10, T15, and T16 are all p-type transistors, and T2, T5, T11, T12, T13, and T14 are all n-type transistors.

FIG. 21B is an operation timing diagram of at least one embodiment of the driving circuit shown in FIG. 21A.

In FIG. 21B, reference sign F1 denotes a frame time, reference sign SX denotes a blanking period, and the blanking period is set at the very beginning of the frame time F1, and reference sign SD denotes a display period included in the frame time FT.

FIG. 21C is an enlarged timing diagram of the blanking period SX in FIG. 21B.

As shown in FIG. 21C, when the driving circuit of at least one embodiment of FIG. 21A of the present disclosure is in operation, the blanking period includes a first period ST1, a second period ST2, a third period ST3 and a fourth period ST4 which are set successively.

In the first period ST1, the second period ST2 and the third period ST3, VCT provides a high voltage signal, T11 and T12 are turned on, the potential of N6 is a low voltage, NT is connected to VGL, T15 and T16 are both turned on, N3 and N4 are both connected to VGL, the first inverter formed by T1 and T2 inverts the driving output signal provided by NT, and OT outputs a high voltage signal.

In the first period ST1, SW provides a low voltage signal and T5 is turned off.

In the second period ST2, SW provides a high voltage signal, VCT provides a high voltage signal, T5 is turned on, and the first data voltage provided by SL1 is written into NC1. Since T5 is an IGZO (indium gallium zinc oxide) TFT (thin film transistor), it takes a certain time to write the first data voltage into NC1.

In the third period ST3, SW provides a low voltage signal, VCT provides a high voltage signal, T5 is turned off, the time for writing the first data voltage into NC1 is up, NC1 is no longer charged, and the potential ofNCl is maintained via C1.

In the fourth period ST4, VCT provides a low voltage signal, T11 and T12 are turned off, T8 is turned on, VGH is continuously written into N2 via T8, and I1 provides an initial voltage Vinit. Since there is a voltage difference between the potential of NC1 and the voltage value of Vinit, the potential of N3 is different from the potential of N4.

In the fourth period ST4, the potential of NC1 is greater than the voltage value of Vinit, and the potential of N3 is less than the potential of N4; at the beginning of the fourth period ST4, T15 and T16 are turned on, the potential of N6 is less than the potential of NT, T16 is turned on, NT outputs a high voltage signal, and OT outputs a low voltage signal.

When the driving circuit of at least one embodiment of FIG. 21A of the present disclosure is in operation, in the fourth period ST4, in a case that the potential of NC1 is less than the voltage value of Vinit, the potential of N3 is greater than the potential of N4, and at the beginning of the fourth period ST4, T15 and T16 are turned on, the potential of N6 is greater than the potential of NT, T14 is turned on, NT outputs a low voltage signal, and OT outputs a high voltage signal.

When the driving circuit of at least one embodiment of FIG. 21A of the present disclosure is in operation, the driving signal output by OT in the display period is the same as the driving signal output by OT in the fourth period ST4; OT outputs a low voltage signal in both the fourth period ST4 and the display period SD; or, OT outputs a high voltage signal in both the fourth period ST4 and the display period SD.

In at least one embodiment of the driving circuit shown in FIG. 21A, T13, T14, T15, and T16 form a latch, and T9 and T10 constitute a differential part.

The driving circuit in at least one embodiment of the present disclosure can provide a driving signal to a gate electrode of a first control transistor M9 in a pixel circuit shown in FIG. 21D via the driving signal output terminal OT.

As shown in FIG. 21D, the pixel circuit of at least one embodiment may include a driving transistor M3, a first initialization transistor M1, a compensation control transistor M2, a data writing transistor M4, a first light emitting control transistor M5, a second light emitting control transistor M6, a second initialization transistor M7, a third initialization transistor M8, a first control transistor M9, a storage capacitor Cst, and an organic light emitting diode O1.

Agate electrode of M5 is electrically connected to a light emitting control line EM, a source electrode of M5 is electrically connected to a power supply voltage terminal VDD, and a drain electrode of M5 is electrically connected to a source electrode of M3.

Agate electrode of M9 is electrically connected to a first control terminal S0, a drain electrode of M9 is electrically connected to a gate electrode of M3, a source electrode of M9 is electrically connected to a drain electrode of M2, and a source electrode of M2 is electrically connected to a drain electrode of M3.

A gate electrode of M1 is electrically connected to a first reset control terminal RP, a source electrode of M1 is electrically connected to a first initial voltage terminal I01, and a drain electrode of M1 is electrically connected to the drain electrode of M3.

A gate electrode of M2 is electrically connected to a compensation control terminal GN.

A gate electrode of M4 is electrically connected to a scanning terminal GP, a source electrode of M4 is electrically connected to a data line DL, and a drain electrode of M4 is electrically connected to the source electrode of M3.

A gate electrode of M6 is electrically connected to the light emitting control line EM, a source electrode of M6 is electrically connected to the drain electrode of M3, a drain electrode of M6 is electrically connected to an anode of 01; a cathode of O1 is electrically connected to a low level terminal VSS.

Agate electrode of M7 is electrically connected to a second reset control terminal RH, a source electrode of M7 is electrically connected to a second initial voltage terminal 102, and a drain electrode of M7 is electrically connected to the anode of O1.

A gate electrode of M8 is electrically connected to the second reset control terminal RH, a source electrode of M8 is electrically connected to a third initial voltage terminal 103, and a drain electrode of M8 is electrically connected to the source electrode of M3.

A first terminal of Cst is electrically connected to the gate electrode of M3, and a second terminal of Cst is electrically connected to the power supply voltage terminal VDD.

In at least one embodiment of the pixel circuit shown in FIG. 21D, M2 and M9 are oxide transistors, M2 and M9 are n-type transistors, and the other transistors are p-type transistors.

When the pixel circuit of at least one embodiment of FIG. 21D is in operation, in a display period included in a frame time, in a case that OT outputs a high voltage signal, M9 is turned on, and the pixel circuit is refreshed normally; in the display period, in a case that OT outputs a low voltage signal, M9 is turned off, and the pixel circuit is not refreshed.

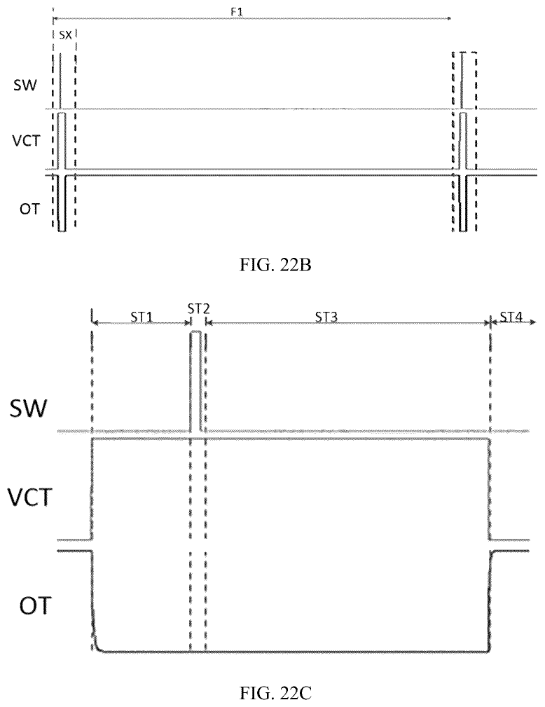

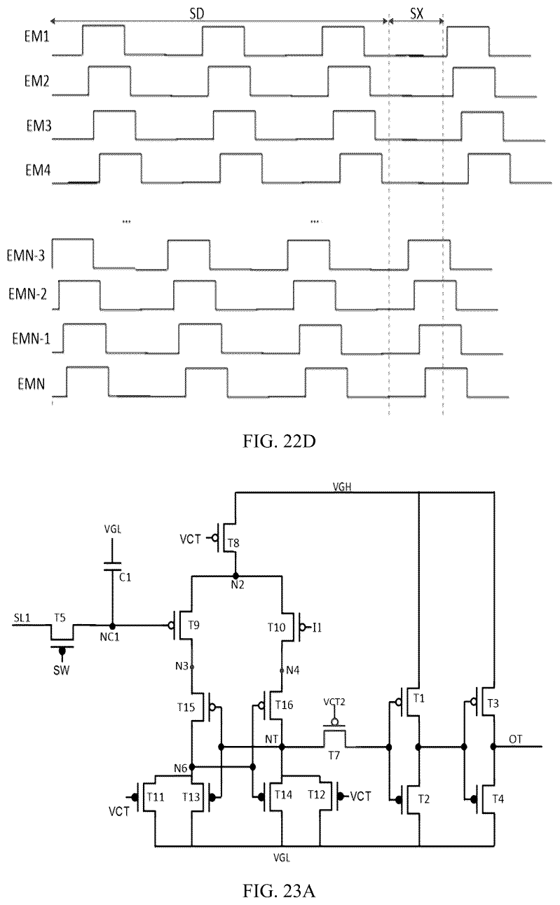

As shown in FIG. 22A, based on at least one embodiment of the pixel circuit shown in FIG. 18:

The inverting circuit includes a first inverter and a second inverter; the first inverter includes a first transistor T1 and a second transistor T2; the second inverter includes a third transistor T3 and a fourth transistor T4.

A gate electrode of the first transistor T1 is electrically connected to the input terminal of the first inverter, a source electrode of the first transistor T1 is electrically connected to the high voltage terminal VGH, and a drain electrode of the first transistor T1 and a source electrode of the second transistor T2 are both electrically connected to the input terminal of the second inverter.

A gate electrode of the second transistor T2 is electrically connected to the input terminal of the first inverter, and a drain electrode of the second transistor T2 is electrically connected to the low voltage terminal.

A gate electrode of the third transistor T3 and a gate electrode of the fourth transistor T4 are both electrically connected to the input terminal of the second inverter, a source electrode of the third transistor T3 is electrically connected to the high voltage terminal VGH, and a drain electrode of the third transistor T3 and a source electrode of the fourth transistor T4 are both electrically connected to the driving signal output terminal OT.

A drain electrode of the fourth transistor T4 is electrically connected to the low voltage terminal VGL.

The first transistor T1 is a p-type transistor, the second transistor T2 is an n-type transistor; the third transistor T3 is a p-type transistor, and the fourth transistor T4 is an n-type transistor.

The input terminal of the first inverter is electrically connected to the driving output terminal NT.

The first data writing circuit includes a fifth transistor T5 and a first capacitor C1.

A gate electrode of the fifth transistor T5 is electrically connected to the switch control terminal SW, a source electrode of the fifth transistor T5 is electrically connected to the first data line SL1, and a drain electrode of the fifth transistor T5 is electrically connected to the first differential control node NC1.

A first terminal of the first capacitor C1 is electrically connected to the first differential control node NC1, and a second terminal of the first capacitor C1 is electrically connected to the low voltage terminal VGL.

The input control circuit includes an eighth transistor T8, and the differential control circuit includes a ninth transistor T9 and a tenth transistor T10.

A gate electrode of the eighth transistor T8 is electrically connected to the output control terminal VCT, a source electrode of the eighth transistor T8 is electrically connected to the high voltage terminal VGH, and a drain electrode of the eighth transistor T8 is electrically connected to the input node N2.

A gate electrode of the ninth transistor T9 is electrically connected to the first differential control node NC1, a source electrode of the ninth transistor T9 is electrically connected to the input node N2, and a drain electrode of the ninth transistor T9 is electrically connected to the first output node N3.

A gate electrode of the tenth transistor T10 is electrically connected to the second differential control node NC2, a source electrode of the tenth transistor T10 is electrically connected to the input node N2, and a drain electrode of the tenth transistor T10 is electrically connected to the second output node N4; the second differential control node NC2 is electrically connected to the initial voltage terminal I1.

The set circuit includes an eleventh transistor TI1 and a twelfth transistor T12.

A gate electrode of the eleventh transistor T11 is electrically connected to the output control terminal VCT, a source electrode of the eleventh transistor T11 is electrically connected to the low voltage terminal VGL.

A gate electrode of the twelfth transistor T12 is electrically connected to the output control terminal VCT, a source electrode of the twelfth transistor T12 is electrically connected to the driving output terminal NT, and a drain electrode of the twelfth transistor T12 is electrically connected to the low voltage terminal VGL.

The eighth transistor T8 is a p-type transistor, and the eleventh transistor T11 and the twelfth transistor T12 are n-type transistors.

The latch circuit includes a thirteenth transistor T13, a fourteenth transistor T14, a fifteenth transistor T15 and a sixteenth transistor T16.

A gate electrode of the thirteenth transistor T13 is electrically connected to the driving output terminal NT, a source electrode of the thirteenth transistor T13 is electrically connected to the intermediate node N6, and a drain electrode of the thirteenth transistor T13 is electrically connected to the low voltage terminal VGL.

Agate electrode of the fourteenth transistor T14 is electrically connected to the intermediate node N6, a source electrode of the fourteenth transistor T14 is electrically connected to the driving output terminal NT, and a drain electrode of the fourteenth transistor T14 is electrically connected to the low voltage terminal VGL.

A gate electrode of the fifteenth transistor T15 is electrically connected to the driving output terminal NT, a source electrode of the fifteenth transistor T15 is electrically connected to the first output node N3, and a drain electrode of the fifteenth transistor T15 is electrically connected to the intermediate node N6.

A gate electrode of the sixteenth transistor T16 is electrically connected to the intermediate node N6, a source electrode of the sixteenth transistor T16 is electrically connected to the second output node N4, and a drain electrode of the sixteenth transistor T16 is electrically connected to the driving output terminal OT.

The thirteenth transistor T13 and the fourteenth transistor T14 are n-type transistors, and the fifteenth transistor T15 and the sixteenth transistor T16 are p-type transistors.

In at least one embodiment shown in FIG. 22A, T1, T3, T8, T9, T10, T15, and T16 are all p-type transistors, and T2, T4, T5, T11, T12, T13, and T14 are all n-type transistors.

In at least one embodiment of the driving circuit shown in FIG. 22A, T1 and T2 form the first inverter, T3 and T4 form the second inverter, and T1, T2, T3, and T4 may be configured to amplify and stabilize the driving output signal, and output the driving signal.

FIG. 22B is an operation timing diagram of at least one embodiment of the driving circuit shown in FIG. 22A.

In FIG. 22B, reference sign F1 denotes a frame time, reference sign SX denotes a blanking period, the blanking period SX is set at the very beginning of the frame time F1, and reference sign SD denotes a display period included in the frame time FT.

As shown in FIG. 22C, when the driving circuit of at least one embodiment of FIG. 22A of the present disclosure is in operation, the blanking period includes a first period ST1, a second period ST2, a third period ST3 and a fourth period ST4 which are set successively.

In the first period ST1, the second period ST2 and the third period ST3, VCT provides a high voltage signal, T11 and T12 are turned on, NT outputs a low voltage signal, and after passing through two phases of inverters, OT outputs a low voltage signal.

In the first period ST1, SW provides a low voltage signal, and T5 is turned off.

In the second period ST2, SW provides a high voltage signal, VCT provides a high voltage signal, T5 is turned on, and the first data voltage provided by SL1 is written into NC1. Since T5 is an IGZO TFT (thin film transistor), it takes a certain time to write the first data voltage into NC1.

In the third period ST3, SW provides a low voltage signal, VCT provides a high voltage signal, T5 is turned off, the time for writing the first data voltage into NC1 is up, NC1 is no longer charged, and the potential of NC1 is maintained via C1.

In the fourth period ST4, VCT provides a low voltage signal, T11 and T12 are turned off, T8 is turned on, VGH is continuously written into N2 via T8, I1 provides an initial voltage Vinit. Since there is a voltage difference between the potential of NC1 and the voltage value of Vinit, there is a difference between the potential of the gate electrode of T9 and the potential of the gate electrode of T10, resulting in a difference in voltage writing speeds or voltage values of the first output node N3 and the second output node N4.

In the fourth period ST4, the potential of NC1 is greater than the voltage value of Vinit, and the potential of N3 is less than the potential of N4; at the beginning of the fourth period ST4, T15 and T16 are turned on, the potential of N6 is less than the potential of NT, T16 is turned on, NT outputs a high voltage signal, and OT outputs a high voltage signal.

When the driving circuit of at least one embodiment of FIG. 22A of the present disclosure is in operation, in the fourth period ST4, in a case that the potential of NC1 is less than the voltage value of Vinit, the potential of N3 is greater than the potential of N4, and at the beginning of the fourth period ST4, T15 and T16 are turned on, the potential of N6 is greater than the potential of NT, T14 is turned on, NT outputs a low voltage signal, and OT outputs a low voltage signal.

When the driving circuit of at least one embodiment of FIG. 22A of the present disclosure is in operation, the driving signal output by OT in the display period is the same as the driving signal output by OT in the fourth period ST4; OT outputs a low voltage signal in both the fourth period ST4 and the display period SD; or, OT outputs a high voltage signal in both the fourth period ST4 and the display period SD.

In at least one embodiment of the driving circuit shown in FIG. 22A, T13, T14, T15, and T16 form a latch, and T9 and T10 form a differential part.

When the driving circuit of at least one embodiment of FIGS. 21A and 22A of the present disclosure is in operation, in the blanking period in each frame time, in a case that the output control signal provided by VCT is being set high, it causes the driving output signal output by NT to have either a pull-down signal or a pull-up signal with the same pulse width as the output control signal provided by VCT, and the driving signal output by OT will also be disturbed.

When the pixel circuit of at least one embodiment of FIG. 21D is in operation, in a case that OT outputs a high voltage signal, M9 is in an on state, and in a case that OT outputs a low voltage signal, M9 is in an off state. There is capacitance between the gate electrode and drain electrode of M9, the capacitance mainly includes: the parasitic capacitance of M9 itself; and the capacitance between nodes other than those of the TFTs in the Layout design; where the capacitance between nodes other than those of the TFTs can be optimized in the design to minimize it as much as possible, but the capacitance of M9 itself is inevitable in the TFT itself and can not be completely eliminated, with a capacitance value in the order of fF, which is considered a large capacitance among capacitances between nodes at the pixel level.

In a case that the light emitting control signal provided by the light emitting control line EM adopts multiple pulses in the display period, as shown in FIG. 22D, the display panel including the pixel circuit of at least one embodiment of FIG. 21D includes multiple row light emitting control lines, and in the display period SD, each row light emitting control line outputs a corresponding light emitting control signal, and each light emitting control signal has three upward pulses.

In the blanking period SX, the light emitting control signals provided by some of the light emitting control lines have rising edges.

In FIG. 22D, reference sign EM1 denotes a first row light emitting control line, reference sign EM2 denotes a second row light emitting control line, reference sign EM3 denotes a third row light emitting control line, reference sign EM4 denotes a fourth row light emitting control line, reference sign EMN-3 denotes an (N-3)-th row light emitting control line, reference sign EMN-2 denotes an (N-2)-th row light emitting control line, reference sign EMN-1 denotes an (N-1)-th row light emitting control line, and reference sign EMN denotes an N-th row light emitting control line; N is an integer greater than 7.

As shown in FIG. 22D, in the blanking period SX, the (N-3)-th row light control signal provided by EMN-3, the (N-2)-th row light control signal provided by EMN-2, the (N-1)-th row light control signal provided by EMN-1, and the N-th row light control signal provided by EMN-1 have rising edges.

In the blanking period, there is a pull-down signal in the driving signal output by OT. In the pixel circuit, there is a capacitance between the gate electrode of M9 and the gate electrode of the driving transistor M3. The pull-down signal of the driving signal has a coupling effect on the potential of the gate electrode of M3, thereby lowering the potential of the gate electrode of M3. When the light emitting control line outputs multiple pulses, some row light emitting control signals are in the off state in the blanking period, most of the light emitting control signals remain in the on state in the blanking period, and the organic light emitting diodes in the pixel circuits are in the light emitting stage. In this case, the change in the potential of the gate electrode of the driving transistor M3 has different effects on the light emitting of the pixel circuits corresponding to these two types of rows, causing brightness differences in different regions, which results in a multi-screen artifacts.

In view of the above problems, optimization solutions can be divided into two categories: one is to reduce the capacitance between the gate electrode of M9 and the gate electrode of the driving transistor M3, and reduce the coupling effect of the disturbance of the driving signal on the gate electrode of M3; the other is to start from the driving circuit that generates the driving signal, which stabilize the driving signal output by the driving circuit. At least one embodiment of the present disclosure provides a driving circuit adopting a switch control circuit. The switch control circuit controls connection or disconnection between a first output control node and a second output control node under control of an on-off control signal provided by an on-off control terminal VCT2, so that a driving signal output by a driving signal output terminal OT is not affected by an output control signal provided by VCT.

In a specific implementation, in the blanking period, a pulse width of the on-off control signal provided by VCT2 is greater than a pulse width of the output control signal provided by VCT, a start time of an effective period of the on-off control signal is earlier than a start time of an effective period of the output control signal, and an end time of the effective period of the on-off control signal is later than an end time of the effective period of the output control signal.

In at least one embodiment of the present disclosure, the effective period of the on-off control signal refers to: a period during which the on-off control signal is an active voltage signal.

The effective period of the output control signal refers to: a period during which the output control signal is an active voltage signal.

When the transistor controlled by the on-off control signal is an n-type transistor, the active voltage signal is a high voltage signal, and when the transistor controlled by the on-off control signal is a p-type transistor, the active voltage signal is a low voltage signal.

When the transistor controlled by the output control signal is an n-type transistor, the active voltage signal is a high voltage signal, and when the transistor controlled by the output control signal is a p-type transistor, the active voltage signal is a low voltage signal.

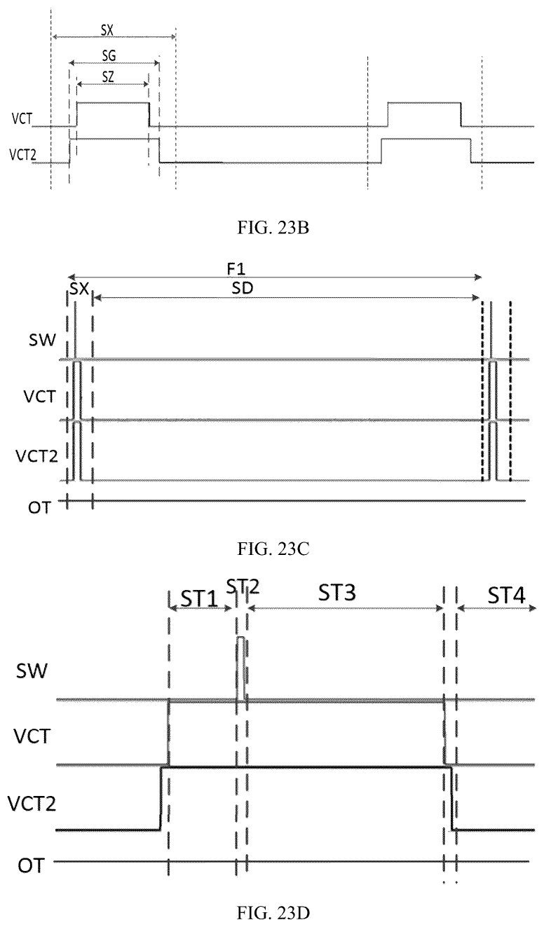

The difference between the driving circuit of at least one embodiment of FIG. 23A and the driving circuit of at least one embodiment of FIG. 22A is as follows:
a switch control circuit is further included;
the switch control circuit includes a seventh transistor T7;
a gate electrode of the seventh transistor T7 is electrically connected to the on-off control terminal VCT2, a source electrode of the seventh transistor T7 is electrically connected to the driving output terminal NT, and a drain electrode of the seventh transistor T7 is electrically connected to the gate electrode of T1.

In at least one embodiment of the driving circuit shown in FIG. 23A, T7 is a p-type transistor, and T7 is an LTPS (low-temperature polysilicon) transistor.

As shown in FIG. 23B, when the driving circuit of at least one embodiment of FIG. 23A of the present disclosure is in operation, a frame time includes a blanking period SX, the blanking period includes an off phase SG, and the off phase SG includes a setting period SZ.

In the setting period SZ, VCT provides a high voltage signal, T11 and T12 are turned on, N6 is connected to VGL, and NT is connected to VGL.

In the off phase SG, VCT2 provides a high voltage signal, and T7 is turned off, so that the driving signal provided by OT is not affected by the output control signal provided by VCT.

In at least one embodiment of the present disclosure, the switch control circuit is additionally provided, the switch control circuit includes the seventh transistor, and the seventh transistor is an isolation TFT (thin film transistor) for isolating changes in the driving output signal caused by signal jumps in each frame in the driving circuit, thereby improving stability of the driving signal and improving display effect of the OLED (organic light emitting diode) display product.

FIG. 23C is an operation timing diagram of at least one embodiment of the driving circuit shown in FIG. 23B.

In FIG. 23C, reference sign F1 denotes a frame time, reference sign SX denotes a blanking period, the blanking period SX is set at the very beginning of the frame time F1, and reference sign SD denotes a display period included in the frame time F1.

As shown in FIG. 23D, when the driving circuit of at least one embodiment of FIG. 23A of the present disclosure is in operation, the blanking period includes a first period ST1, a second period ST2, a third period ST3 and a fourth period ST4 which are set successively.

In the first period ST1, the second period ST2 and the third period ST3, VCT provides a high voltage signal, T11 and T12 are turned on, N6 and NT are connected to VGL, T15 and T16 are turned on, NT outputs a low voltage signal, T7 is turned off, and OT maintains outputting a high voltage signal.

In the first period ST1, SW provides a low voltage signal and T5 is turned off.

In the second period ST2, SW provides a high voltage signal, VCT provides a high voltage signal, T5 is turned on, and the first data voltage provided by SL1 is written into NC1. Since T5 is an IGZO TFT (thin film transistor), it takes a certain time to write the first data voltage into NC1.

In the third period ST3, SW provides a low voltage signal, VCT provides a high voltage signal, T5 is turned off, the time for writing the first data voltage into NC1 is up, NC1 is no longer charged, and the potential of NC1 is maintained via C1.

In the fourth period ST4, VCT provides a low voltage signal, T11 and T12 are turned off, T8 is turned on, VGH is continuously written into N2 via T8, and I1 provides an initial voltage Vinit. Since there is a voltage difference between the potential of NC1 and the voltage value of Vinit, the potential of N3 is different from the potential of N4.

In the fourth period ST4, VCT2 provides a low voltage signal and T7 is turned on.

In the fourth period ST4, the potential of NC1 is greater than the voltage value of Vinit, and the potential of N3 is less than the potential of N4; at the beginning of the fourth period ST4, T15 and T16 are turned on, the potential of N6 is less than the potential of NT, T16 is turned on, NT outputs a high voltage signal, and OT outputs a high voltage signal.

When the driving circuit of at least one embodiment of FIG. 23A of the present disclosure is in operation, in the fourth period ST4, in a case that the potential of NC1 is less than the voltage value of Vinit, the potential of N3 is greater than the potential of N4, and at the beginning of the fourth period ST4, T15 and T16 are turned on, the potential of N6 is greater than the potential of NT, T14 is turned on, NT outputs a low voltage signal, and OT outputs a low voltage signal.

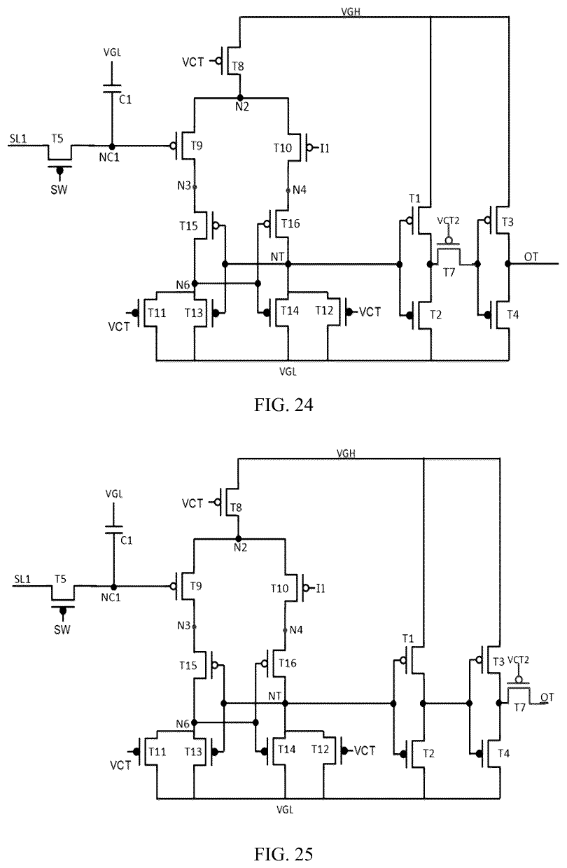

The difference between the driving circuit of at least one embodiment of FIG. 24 and the driving circuit of at least one embodiment of FIG. 22A is as follows:
a switch control circuit is included;
the switch control circuit includes a seventh transistor T7;
a gate electrode of the seventh transistor T7 is electrically connected to the on-off control terminal VCT2, a source electrode of the seventh transistor T7 is electrically connected to the drain electrode of T1, and a drain electrode of the seventh transistor T7 is electrically connected to the gate electrode of T3.

In at least one embodiment of the driving circuit shown in FIG. 24, T7 is a p-type transistor, and T7 is an LTPS (low-temperature polysilicon) transistor.

As shown in FIG. 23B, when the driving circuit of at least one embodiment of FIG. 24 of the present disclosure is in operation, a frame time includes a blanking period SX, the blanking period includes an off phase SG, and the off phase SG includes a setting period SZ.

In the setting period SZ, VCT provides a high voltage signal, T11 and T12 are turned on, N6 is connected to VGL, and NT is connected to VGL.

In the off phase SG, VCT2 provides a high voltage signal, and T7 is turned off, so that the driving signal provided by OT is not affected by the output control signal provided by VCT.

The difference between the driving circuit of at least one embodiment of FIG. 25 and the driving circuit of at least one embodiment of FIG. 22A is as follows:
a switch control circuit is further included;
the switch control circuit includes a seventh transistor T7;
a gate electrode of the seventh transistor T7 is electrically connected to the on-off control terminal VCT2, a source electrode of the seventh transistor T7 is electrically connected to a drain electrode of T3, and a drain electrode of the seventh transistor T7 is electrically connected to the driving signal output terminal OT.

In at least one embodiment of the driving circuit shown in FIG. 25, T7 is a p-type transistor, and T7 is an LTPS (low-temperature polysilicon) transistor.

As shown in FIG. 23B, when the driving circuit of at least one embodiment of FIG. 25 of the present disclosure is in operation, a frame time includes a blanking period SX, the blanking period includes an off phase SG, and the off phase SG includes a setting period SZ.

In the setting period SZ, VCT provides a high voltage signal, T11 and T12 are turned on, N6 is connected to VGL, and NT is connected to VGL.

In the off phase SG, VCT2 provides a high voltage signal, and T7 is turned off, so that the driving signal provided by OT is not affected by the output control signal provided by VCT.

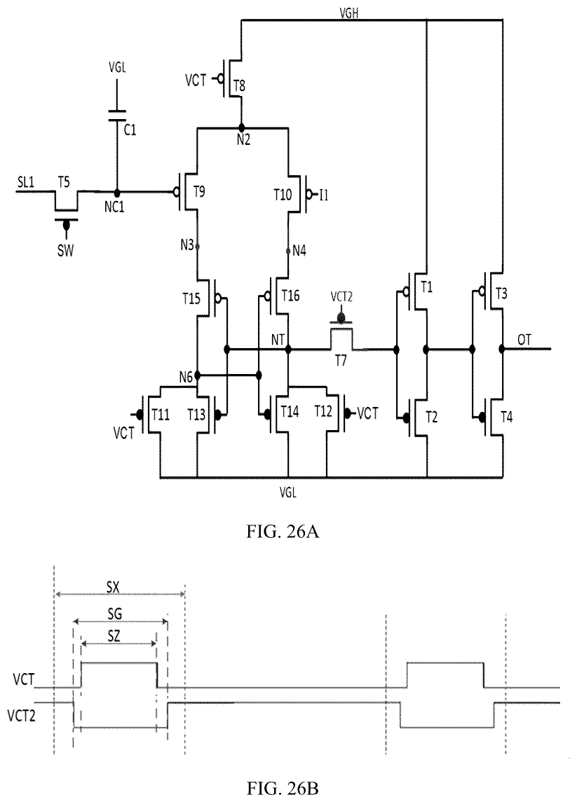

The difference between the driving circuit of at least one embodiment of FIG. 26A and the driving circuit of at least one embodiment of FIG. 22A is as follows:
a switch control circuit is further included;
the switch control circuit includes a seventh transistor T7;
a gate electrode of the seventh transistor T7 is electrically connected to the on-off control terminal VCT2, a source electrode of the seventh transistor T7 is electrically connected to the driving output terminal NT, and a drain electrode of the seventh transistor T7 is electrically connected to the gate electrode of T1.

In the driving circuit of at least one embodiment of FIG. 26A, T7 is an n-type transistor, and T7 is an IGZO (indium gallium zinc oxide) transistor.

As shown in FIG. 26B, when the driving circuit of at least one embodiment of FIG. 26A of the present disclosure is in operation, a frame time includes a blanking period SX, the blanking period includes an off phase SG, and the off phase SG includes a setting period SZ.

In the setting period SZ, VCT provides a high voltage signal, T11 and T12 are turned on, N6 is connected to VGL, and NT is connected to VGL.

In the off phase SG, VCT2 provides a low voltage signal, and T7 is turned off, so that the driving signal provided by OT is not affected by the output control signal provided by VCT.

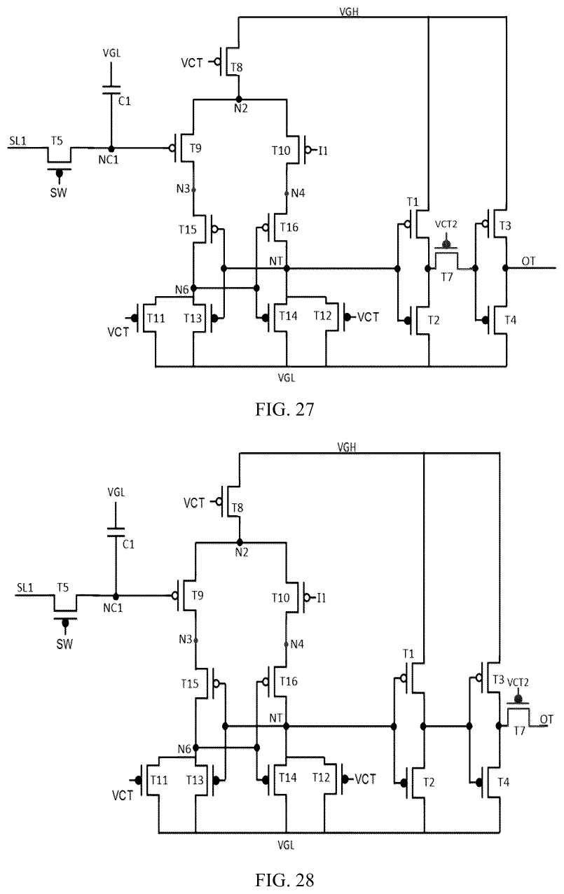

The difference between the driving circuit of at least one embodiment of FIG. 27 and the driving circuit of at least one embodiment of FIG. 22A is as follows:
a switch control circuit is further included;
the switch control circuit includes a seventh transistor T7;
a gate electrode of the seventh transistor T7 is electrically connected to the on-off control terminal VCT2, a source electrode of the seventh transistor T7 is electrically connected to the drain electrode of T1, and a drain electrode of the seventh transistor T7 is electrically connected to the gate electrode of T3.

In at least one embodiment of the driving circuit shown in FIG. 27, T7 is an n-type transistor, and T7 is an IGZO (indium gallium zinc oxide) transistor.

As shown in FIG. 26B, when the driving circuit of at least one embodiment of FIG. 27 of the present disclosure is in operation, a frame time includes a blanking period SX, the blanking period includes an off phase SG, and the off phase SG includes a setting period SZ.

In the setting period SZ, VCT provides a high voltage signal, T11 and T12 are turned on, N6 is connected to VGL, and NT is connected to VGL.

In the off phase SG, VCT2 provides a low voltage signal, and T7 is turned off, so that the driving signal provided by OT is not affected by the output control signal provided by VCT.

The difference between the driving circuit of at least one embodiment of FIG. 28 and the driving circuit of at least one embodiment of FIG. 22A is as follows:
a switch control circuit is further included;
the switch control circuit includes a seventh transistor T7;
a gate electrode of the seventh transistor T7 is electrically connected to the on-off control terminal VCT2, a source electrode of the seventh transistor T7 is electrically connected to the drain electrode of T3, and a drain electrode of the seventh transistor T7 is electrically connected to the driving signal output terminal OT.

In at least one embodiment of the driving circuit shown in FIG. 28, T7 is an n-type transistor, and T7 is an IGZO (indium gallium zinc oxide) transistor.

As shown in FIG. 26B, when the driving circuit of at least one embodiment of FIG. 28 of the present disclosure is in operation, a frame time includes a blanking period SX, the blanking period includes an off phase SG, and the off phase SG includes a setting period SZ.

In the setting period SZ, VCT provides a high voltage signal, T11 and T12 are turned on, N6 is connected to VGL, and NT is connected to VGL.

In the off phase SG, VCT2 provides a low voltage signal, and T7 is turned off, so that the driving signal provided by OT is not affected by the output control signal provided by VCT.

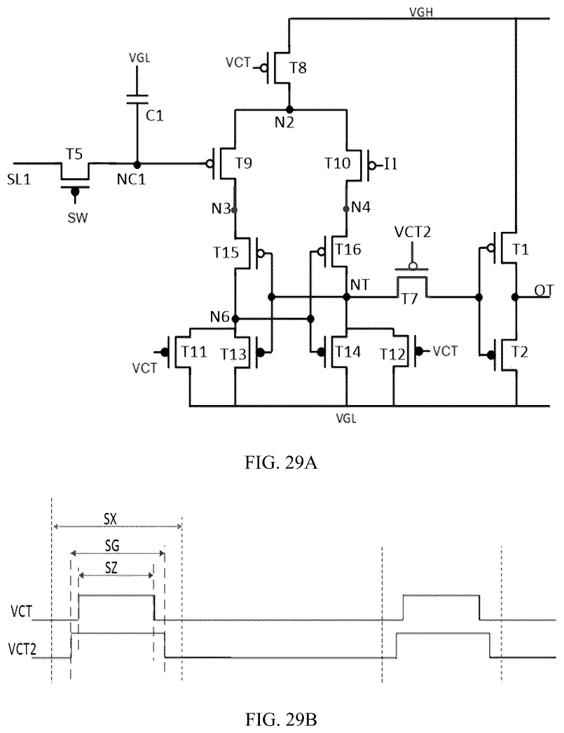

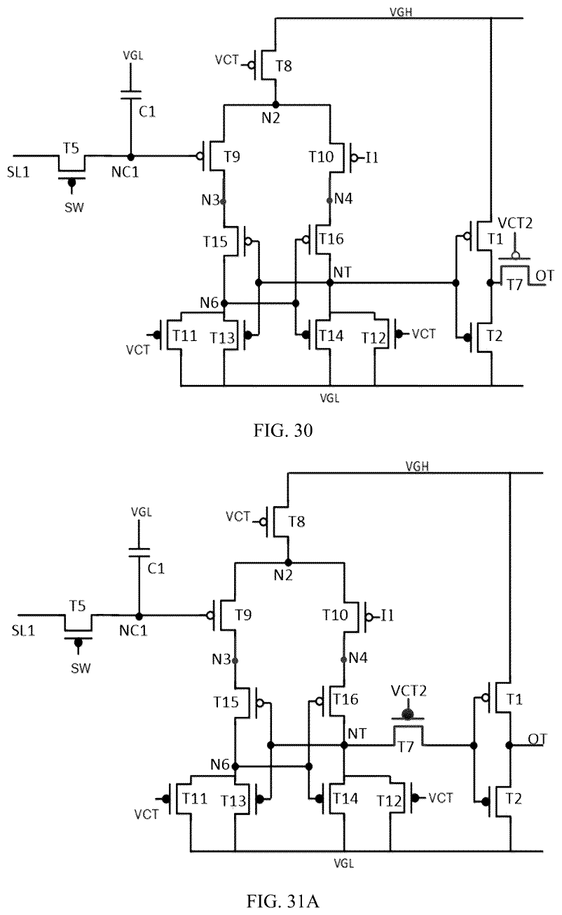

The difference between the driving circuit of at least one embodiment of FIG. 29A and the driving circuit of at least one embodiment of FIG. 21A is as follows:
a switch control circuit is further included;
the switch control circuit includes a seventh transistor T7;
a gate electrode of the seventh transistor T7 is electrically connected to the on-off control terminal VCT2, a source electrode of the seventh transistor T7 is electrically connected to the driving output terminal NT, and a drain electrode of the seventh transistor T7 is electrically connected to the gate electrode of T1.

In at least one embodiment of the driving circuit shown in FIG. 29A, T7 is a p-type transistor, and T7 is an LTPS (low-temperature polysilicon) transistor.

As shown in FIG. 29B, when the driving circuit of at least one embodiment of FIG. 29A of the present disclosure is in operation, a frame time includes a blanking period SX, the blanking period includes an off phase SG, and the off phase SG includes a setting period SZ.

In the setting period SZ, VCT provides a high voltage signal, T11 and T12 are turned on, N6 is connected to VGL, and NT is connected to VGL.

In the off phase SG, VCT2 provides a high voltage signal, and T7 is turned off, so that the driving signal provided by OT is not affected by the output control signal provided by VCT.

The difference between the driving circuit of at least one embodiment of FIG. 30 and the driving circuit of at least one embodiment of FIG. 21A is as follows:
a switch control circuit is further included;
the switch control circuit includes a seventh transistor T7;
a gate electrode of the seventh transistor T7 is electrically connected to the on-off control terminal VCT2, a source electrode of the seventh transistor T7 is electrically connected to the drain electrode of T1, and a drain electrode of the seventh transistor T7 is electrically connected to the driving signal output terminal OT.

In at least one embodiment of the driving circuit shown in FIG. 30, T7 is a p-type transistor, and T7 is an LTPS (low-temperature polysilicon) transistor.

As shown in FIG. 29B, when the driving circuit of at least one embodiment of FIG. 30 of the present disclosure is in operation, a frame time includes a blanking period SX, the blanking period includes an off phase SG, and the off phase SG includes a setting period SZ.

In the setting period SZ, VCT provides a high voltage signal, T11 and T12 are turned on, N6 is connected to VGL, and NT is connected to VGL.

In the off phase SG, VCT2 provides a high voltage signal, and T7 is turned off, so that the driving signal provided by OT is not affected by the output control signal provided by VCT.

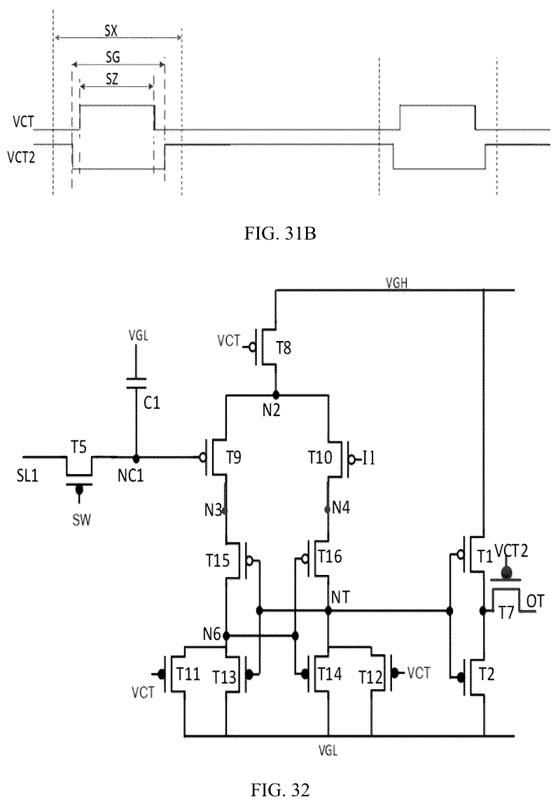

The difference between the driving circuit of at least one embodiment of FIG. 31A and the driving circuit of at least one embodiment of FIG. 21A is as follows:
a switch control circuit is further included;
the switch control circuit includes a seventh transistor T7;
a gate electrode of the seventh transistor T7 is electrically connected to the on-off control terminal VCT2, a source electrode of the seventh transistor T7 is electrically connected to the driving output terminal NT, and a drain electrode of the seventh transistor T7 is electrically connected to the gate electrode of T1.

In at least one embodiment of the driving circuit shown in FIG. 31A, T7 is an n-type transistor, and T7 is an IGZO (indium gallium zinc oxide) transistor.

As shown in FIG. 31B, when the driving circuit of at least one embodiment of FIG. 31A of the present disclosure is in operation, a frame time includes a blanking period SX, the blanking period includes an off phase SG, and the off phase SG includes a setting period SZ.

In the setting period SZ, VCT provides a high voltage signal, T11 and T12 are turned on, N6 is connected to VGL, and NT is connected to VGL.

In the off phase SG, VCT2 provides a low voltage signal, and T7 is turned off, so that the driving signal provided by OT is not affected by the output control signal provided by VCT.

The difference between the driving circuit of at least one embodiment of FIG. 32 and the driving circuit of at least one embodiment of FIG. 21A is as follows:
a switch control circuit is further included;
the switch control circuit includes a seventh transistor T7;
a gate electrode of the seventh transistor T7 is electrically connected to the on-off control terminal VCT2, a source electrode of the seventh transistor T7 is electrically connected to the drain electrode of T1, and a drain electrode of the seventh transistor T7 is electrically connected to the driving signal output terminal OT.

In at least one embodiment of the driving circuit shown in FIG. 32, T7 is an n-type transistor, and T7 is an IGZO (indium gallium zinc oxide) transistor.

As shown in FIG. 31B, when the driving circuit of at least one embodiment of FIG. 32 of the present disclosure is in operation, a frame time includes a blanking period SX, the blanking period includes an off phase SG, and the off phase SG includes a setting period SZ.

In the setting period SZ, VCT provides a high voltage signal, T11 and T12 are turned on, N6 is connected to VGL, and NT is connected to VGL.

In the off phase SG, VCT2 provides a low voltage signal, and T7 is turned off, so that the driving signal provided by OT is not affected by the output control signal provided by VCT.

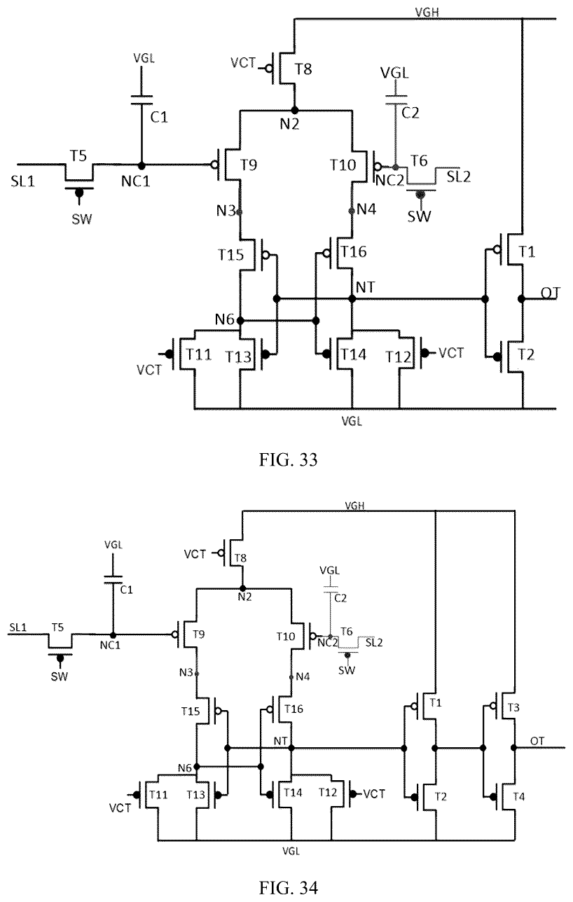

The difference between the driving circuit of at least one embodiment of FIG. 33 and the driving circuit of at least one embodiment of FIG. 21A is as follows: a second data writing circuit is further included;
the second data writing circuit includes a sixth transistor T6 and a second capacitor C2;
a gate electrode of the sixth transistor T6 is electrically connected to the switch control terminal SW, a source electrode of the sixth transistor T6 is electrically connected to the second data line SL2, and a drain electrode of the sixth transistor T6 is electrically connected to the second differential control node NC2;
a first terminal of the second capacitor C2 is electrically connected to the second differential control node NC2, and a second terminal of the second capacitor C2 is electrically connected to the low voltage terminal VGL.

In at least one embodiment of the driving circuit shown in FIGS. 33 to 44, T6 is an n-type transistor.

In at least one embodiment of the driving circuit shown in FIGS. 33 to 44 of the present disclosure, in a case that SW provides a high voltage signal, the first data voltage provided by SL1 is written into NC1, the second data voltage provided by SL2 is written into NC2, the potential of NC1 and the potential of NC2 are differentiated, the first data voltage provided by SL1 is a low voltage signal, and the second data voltage provided by SL2 is a high voltage signal; or, the first data voltage provided by SL1 is a high voltage signal, and the second data voltage provided by SL2 is a low voltage signal. For example, the first data voltage is a 7V voltage signal, and the second data voltage is a OV voltage signal; or, the first data voltage is a OV voltage signal, and the second data voltage is a 7V voltage signal. When one of the first data voltage and the second data voltage is high and the other is low, T15 and T16 can achieve better differential functionality. There is a relatively large difference between the potential of the first differential control node NC1 and the potential of the second differential control node NC2, therefore, for the driving circuit of at least one embodiment of FIGS. 21A and 22A, the differential effect of T15 and T16 is more significant, and the margin of the driving circuit is larger.

In at least one embodiment of the driving circuit shown in FIGS. 33 to 44, since the driving circuit requires the simultaneous use of data voltages from two adjacent data lines, the partial refresh control resolution in the column direction is relatively high; a single stage of driving circuit can drive two adjacent rows of pixel circuits.

The difference between the driving circuit of at least one embodiment of FIG. 34 and the driving circuit of at least one embodiment of FIG. 22A is as follows: a second data writing circuit is further included;
the second data writing circuit includes a sixth transistor T6 and a second capacitor C2;
a gate electrode of the sixth transistor T6 is electrically connected to the switch control terminal SW, a source electrode of the sixth transistor T6 is electrically connected to the second data line SL2, and a drain electrode of the sixth transistor T6 is electrically connected to the second differential control node NC2;
a first terminal of the second capacitor C2 is electrically connected to the second differential control node NC2, and a second terminal of the second capacitor C2 is electrically connected to the low voltage terminal VGL.

Optionally, the second voltage terminal may be a low voltage terminal.

The difference between the driving circuit of at least one embodiment of FIG. 35 and the driving circuit of at least one embodiment of FIG. 23A is as follows: a second data writing circuit is further included;
the second data writing circuit includes a sixth transistor T6 and a second capacitor C2;
a gate electrode of the sixth transistor T6 is electrically connected to the switch control terminal SW, a source electrode of the sixth transistor T6 is electrically connected to the second data line SL2, and a drain electrode of the sixth transistor T6 is electrically connected to the second differential control node NC2;
a first terminal of the second capacitor C2 is electrically connected to the second differential control node NC2, and a second terminal of the second capacitor C2 is electrically connected to the low voltage terminal VGL.

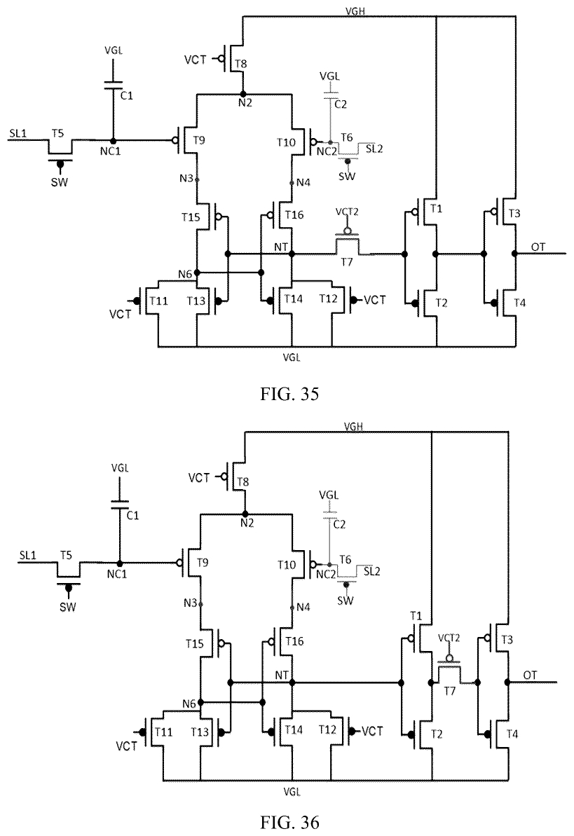

The difference between the driving circuit of at least one embodiment of FIG. 36 and the driving circuit of at least one embodiment of FIG. 24 is as follows: a second data writing circuit is further included;
the second data writing circuit includes a sixth transistor T6 and a second capacitor C2;
a gate electrode of the sixth transistor T6 is electrically connected to the switch control terminal SW, a source electrode of the sixth transistor T6 is electrically connected to the second data line SL2, and a drain electrode of the sixth transistor T6 is electrically connected to the second differential control node NC2;
a first terminal of the second capacitor C2 is electrically connected to the second differential control node NC2, and a second terminal of the second capacitor C2 is electrically connected to the low voltage terminal VGL.

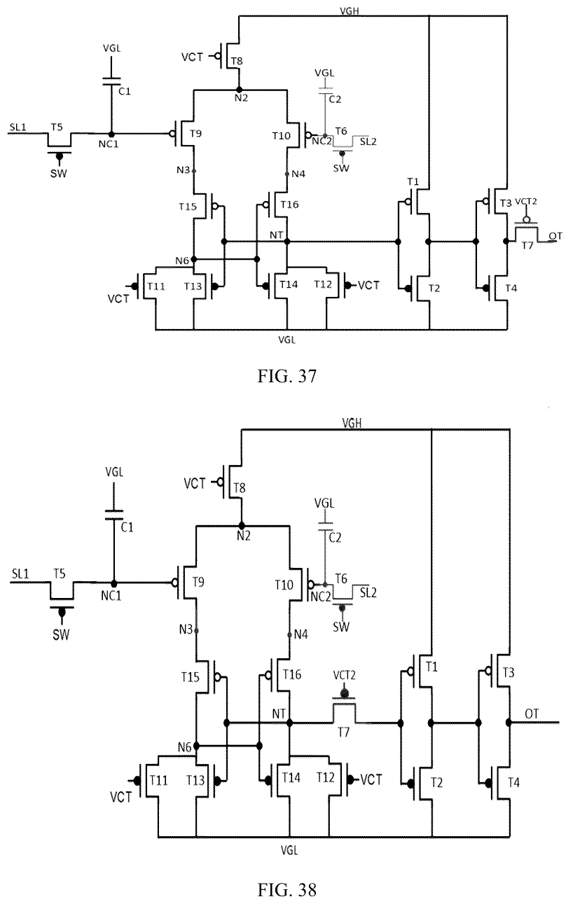

The difference between the driving circuit of at least one embodiment of FIG. 37 and the driving circuit of at least one embodiment of FIG. 25 is as follows: a second data writing circuit is further included;
the second data writing circuit includes a sixth transistor T6 and a second capacitor C2;
a gate electrode of the sixth transistor T6 is electrically connected to the switch control terminal SW, a source electrode of the sixth transistor T6 is electrically connected to the second data line SL2, and a drain electrode of the sixth transistor T6 is electrically connected to the second differential control node NC2;
a first terminal of the second capacitor C2 is electrically connected to the second differential control node NC2, and a second terminal of the second capacitor C2 is electrically connected to the low voltage terminal VGL.

The difference between the driving circuit of at least one embodiment of FIG. 38 and the driving circuit of at least one embodiment of FIG. 26A is as follows: a second data writing circuit is further included;
the second data writing circuit includes a sixth transistor T6 and a second capacitor C2;
a gate electrode of the sixth transistor T6 is electrically connected to the switch control terminal SW, a source electrode of the sixth transistor T6 is electrically connected to the second data line SL2, and a drain electrode of the sixth transistor T6 is electrically connected to the second differential control node NC2;
a first terminal of the second capacitor C2 is electrically connected to the second differential control node NC2, and a second terminal of the second capacitor C2 is electrically connected to the low voltage terminal VGL.

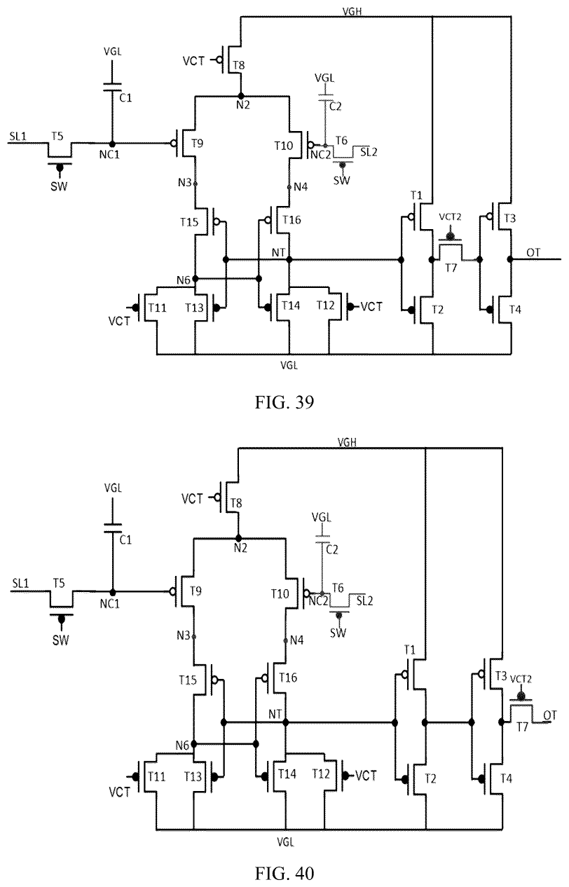

The difference between the driving circuit of at least one embodiment of FIG. 39 and the driving circuit of at least one embodiment of FIG. 27 is as follows: a second data writing circuit is further included;
the second data writing circuit includes a sixth transistor T6 and a second capacitor C2;
a gate electrode of the sixth transistor T6 is electrically connected to the switch control terminal SW, a source electrode of the sixth transistor T6 is electrically connected to the second data line SL2, and a drain electrode of the sixth transistor T6 is electrically connected to the second differential control node NC2;
a first terminal of the second capacitor C2 is electrically connected to the second differential control node NC2, and a second terminal of the second capacitor C2 is electrically connected to the low voltage terminal VGL.

The difference between the driving circuit of at least one embodiment of FIG. 40 and the driving circuit of at least one embodiment of FIG. 28 is as follows: a second data writing circuit is further included;
the second data writing circuit includes a sixth transistor T6 and a second capacitor C2;
a gate electrode of the sixth transistor T6 is electrically connected to the switch control terminal SW, a source electrode of the sixth transistor T6 is electrically connected to the second data line SL2, and a drain electrode of the sixth transistor T6 is electrically connected to the second differential control node NC2;
a first terminal of the second capacitor C2 is electrically connected to the second differential control node NC2, and a second terminal of the second capacitor C2 is electrically connected to the low voltage terminal VGL.

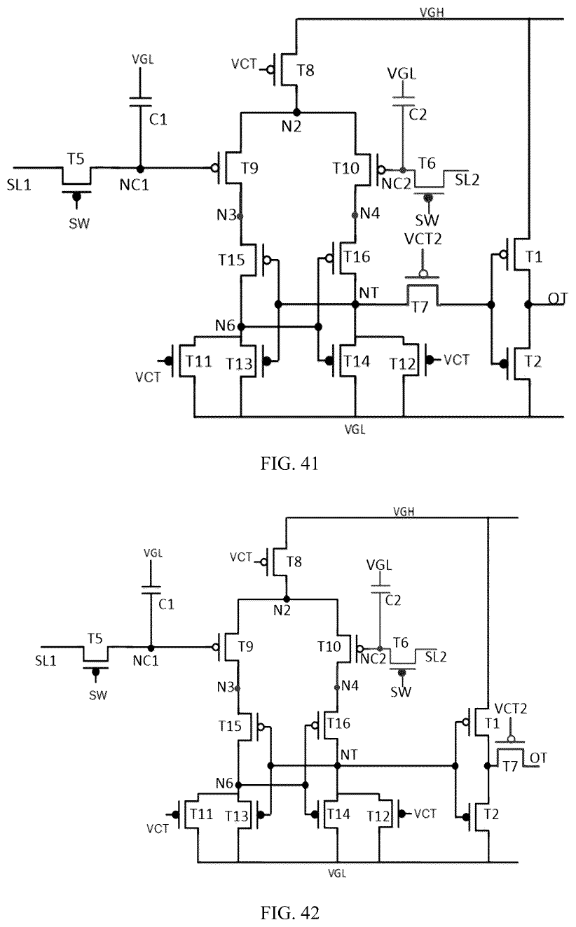

The difference between the driving circuit of at least one embodiment of FIG. 41 and the driving circuit of at least one embodiment of FIG. 29A is as follows: a second data writing circuit is further included;
the second data writing circuit includes a sixth transistor T6 and a second capacitor C2;
a gate electrode of the sixth transistor T6 is electrically connected to the switch control terminal SW, a source electrode of the sixth transistor T6 is electrically connected to the second data line SL2, and a drain electrode of the sixth transistor T6 is electrically connected to the second differential control node NC2;
a first terminal of the second capacitor C2 is electrically connected to the second differential control node NC2, and a second terminal of the second capacitor C2 is electrically connected to the low voltage terminal VGL.

The difference between the driving circuit of at least one embodiment of FIG. 42 and the driving circuit of at least one embodiment of FIG. 30 is as follows: a second data writing circuit is further included;
the second data writing circuit includes a sixth transistor T6 and a second capacitor C2;
a gate electrode of the sixth transistor T6 is electrically connected to the switch control terminal SW, a source electrode of the sixth transistor T6 is electrically connected to the second data line SL2, and a drain electrode of the sixth transistor T6 is electrically connected to the second differential control node NC2;
a first terminal of the second capacitor C2 is electrically connected to the second differential control node NC2, and a second terminal of the second capacitor C2 is electrically connected to the low voltage terminal VGL.

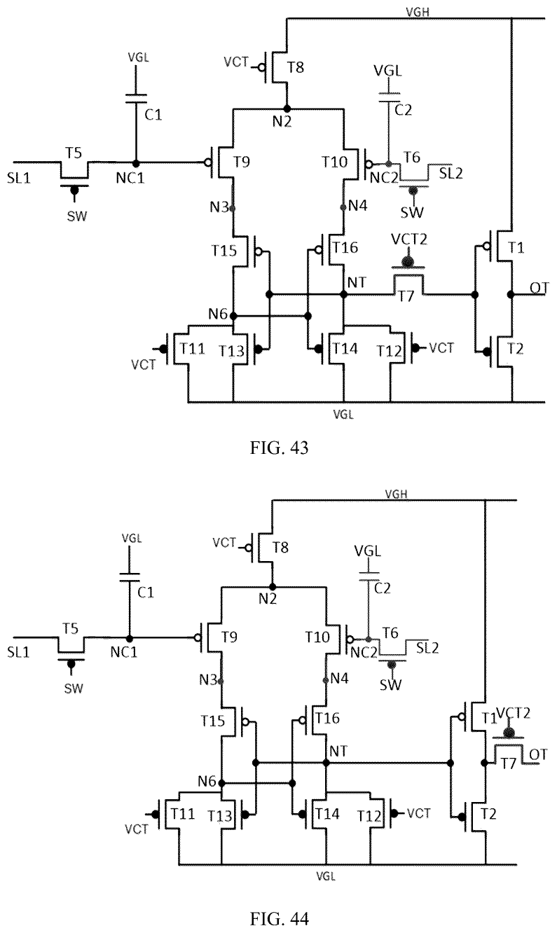

The difference between the driving circuit of at least one embodiment of FIG. 43 and the driving circuit of at least one embodiment of FIG. 31A is as follows: a second data writing circuit is further included;
the second data writing circuit includes a sixth transistor T6 and a second capacitor C2;
a gate electrode of the sixth transistor T6 is electrically connected to the switch control terminal SW, a source electrode of the sixth transistor T6 is electrically connected to the second data line SL2, and a drain electrode of the sixth transistor T6 is electrically connected to the second differential control node NC2;
a first terminal of the second capacitor C2 is electrically connected to the second differential control node NC2, and a second terminal of the second capacitor C2 is electrically connected to the low voltage terminal VGL.

The difference between the driving circuit of at least one embodiment of FIG. 44 and the driving circuit of at least one embodiment of FIG. 32 is as follows: a second data writing circuit is further included;
the second data writing circuit includes a sixth transistor T6 and a second capacitor C2;
a gate electrode of the sixth transistor T6 is electrically connected to the switch control terminal SW, a source electrode of the sixth transistor T6 is electrically connected to the second data line SL2, and a drain electrode of the sixth transistor T6 is electrically connected to the second differential control node NC2;
a first terminal of the second capacitor C2 is electrically connected to the second differential control node NC2, and a second terminal of the second capacitor C2 is electrically connected to the low voltage terminal VGL.

A driving method according to the embodiments of the present disclosure, applied to the above driving circuit, including:
providing, by output circuit, the driving output signal via the driving output terminal based on the data voltage under control of the switch control signal and the output control signal; and
inverting, by the inverter included in the inverting circuit, the signal received by the input terminal of the inverter, to obtain the inverted signal, and outputting the inverted signal via the output terminal of the inverter.

In at least one embodiment of the present disclosure, the output circuit includes a first data writing circuit, a differential control circuit, an input control circuit and an output control circuit, the output control circuit includes a latch circuit and a set circuit, a frame time includes a blanking period, the blanking period includes a setting period and an output phase, the setting period includes a reset phase, a data writing phase and a potential maintaining phase, and the driving method includes:
in the reset phase, controlling, by the set circuit, connection between an intermediate node and a second voltage terminal and connection between the driving output terminal and the second voltage terminal under control of the output control signal;
in the data writing phase, writing, by the first data writing circuit, a first data voltage provided by a first data line into a first differential control node under control of the switch control signal;
in the potential maintaining phase, maintaining, by the first data writing circuit, a potential of the first differential control node; and
in the output phase, controlling, by the input control circuit, connection between an input node and a first voltage terminal under control of the output control signal; controlling, by the differential control circuit, a potential of a first output node and a potential of a second output node based on a potential of the input node under control of the potential of the first differential control node and a potential of the second differential control node; controlling, by the latch circuit, the potential of the driving output terminal based on the potential of the first output node and the potential of the second output node under control of a potential of the intermediate node.

In at least one embodiment of the present disclosure, the output circuit further includes a second data writing circuit, and the driving method further includes:
in the data writing phase, writing, by the second data writing circuit, a second data voltage provided by a second data line into the second differential control node under control of the switch control signal; and
in the potential maintaining phase, maintaining, by the second data writing circuit, the potential of the second differential control node.

Optionally, the driving circuit further includes a switch control circuit, the blanking period includes an off phase, the off phase includes the setting period, and the driving method further includes:
in the off phase, controlling, by the switch control circuit, disconnection between the first output control node and the second output control node under control of an on-off control signal.

A display device according to the embodiments of the present disclosure includes the above driving circuit.

The above descriptions are preferred embodiments of the present disclosure. It should be noted that those skilled in the art that can make various improvements and modifications without departing from the principle of the present disclosure, and the improvements and the modifications shall fall within the scope of protection of the present disclosure.

1. A driving circuit, comprising: an output circuit and an inverting circuit;
wherein the output circuit is electrically connected to an output control terminal, a switch control terminal, a data line and a driving output terminal, and is configured to provide a driving output signal via the driving output terminal based on a data voltage provided by the data line under control of a switch control signal provided by the switch control terminal and an output control signal provided by the output control terminal;
wherein the inverting circuit comprises N stages of inverters, N is a positive integer;
wherein an input terminal of a first inverter is electrically connected to the driving output terminal, and an output terminal of an N-th inverter is electrically connected to a driving signal output terminal;
wherein in a case that N is greater than 1, an output terminal of an m-th inverter is electrically connected to an input terminal of an (m+1)-th inverter, and m is a positive integer less than N; and
wherein the inverter is configured to invert a signal received by received by the input terminal of the inverter to obtain an inverted signal, and output the inverted signal via the output terminal of the inverter.

2. The driving circuit according to claim 1, wherein the output circuit comprises a first data writing circuit, a differential control circuit, an input control circuit and an output control circuit;
wherein the first data writing circuit is electrically connected to the switch control terminal, a first data line and a first differential control node, and is configured to write a first data voltage provided by the first data line into the first differential control node and maintain a potential of the first differential control node under control of the switch control signal provided by the switch control terminal;
wherein the differential control circuit is electrically connected to the first differential control node, a second differential control node, an input node, a first output node, and a second output node, and is configured to control a potential of the first output node and a potential of the second output node based on a potential of the input node under control of the potential of the first differential control node and a potential of the second differential control node;
wherein the input control circuit is electrically connected to the output control terminal, the input node and a first voltage terminal, and is configured to control connection or disconnection between the input node and the first voltage terminal under control of the output control signal provided by the output control terminal; and
wherein the output control circuit is electrically connected to the output control terminal, the first output node, the second output node and the driving output terminal, and is configured to generate the driving output signal and provide the driving output signal via the driving output terminal based on the potential of the first output node and the potential of the second output node under control of the output control signal.

3. The driving circuit according to claim 2, wherein the output control circuit comprises a latch circuit and a set circuit;
wherein the set circuit is electrically connected to the output control terminal, an intermediate node, the driving output terminal and a second voltage terminal, and is configured to control connection or disconnection between the intermediate node and the second voltage terminal and control connection or disconnection between the driving output terminal and the second voltage terminal under control of the output control signal; and
wherein the latch circuit is electrically connected to the first output node, the second output node, the intermediate node, the driving output terminal and the second voltage terminal, and is configured to control a potential of the driving output terminal based on the potential of the first output node and the potential of the second output node under control of a potential of the intermediate node.

4. The driving circuit according to claim 3, wherein the output circuit further comprises a second data writing circuit;
wherein the second data writing circuit is electrically connected to the switch control terminal, a second data line and the second differential control node, and is configured to write a second data voltage provided by the second data line into the second differential control node and maintain the potential of the second differential control node under control of the switch control signal provided by the switch control terminal;
or,
wherein the driving circuit further comprises a switch control circuit;
wherein the switch control circuit is electrically connected to an on-off control terminal, a first output control node and a second output control node, and is configured to control connection or disconnection between the first output control node and the second output control node under control of an on-off control signal provided by the on-off control terminal;
wherein the first output control node is electrically connected to the driving output terminal, and the second output control node is electrically connected to the input terminal of the first inverter; or,
the first output control node is electrically connected to the output terminal of the N-th inverter, and the second output control node is electrically connected to the driving signal output terminal; or,
N is greater than 1, the first output control node is electrically connected to the output terminal of the m-th inverter, and the second output control node is electrically connected to the input terminal of the (m+1)-th inverter.

5. (canceled)

6. The driving circuit according to claim 4, wherein the latch circuit is configured to control connection or disconnection between the second output node and the driving output terminal and connection or disconnection between the driving output terminal and the second voltage terminal under control of the potential of the intermediate node, and to control connection or disconnection between the first output node and the intermediate node and connection or disconnection between the intermediate node and the second voltage terminal under control of the potential of the driving output terminal.

7. The driving circuit according to claim 6, wherein a frame time comprises a blanking period, the blanking period comprises an off phase, and the off phase comprises a setting period;
wherein the set circuit is configured to control connection between the intermediate node and the second voltage terminal and control connection between the driving output terminal and the second voltage terminal under control of the output control signal during the setting period; and
wherein the switch control circuit is configured to control disconnection between the first output control node and the second output control node under control of the on-off control signal during the off phase.

8. The driving circuit according to claim 1, wherein N is equal to 1, the inverting circuit comprises the first inverter, and the first inverter comprises a first transistor and a second transistor;
wherein a gate electrode of the first transistor is electrically connected to the input terminal of the first inverter, a first electrode of the first transistor is electrically connected to a first voltage terminal, and a second electrode of the first transistor and a first electrode of the second transistor are both electrically connected to the driving signal output terminal;
wherein a gate electrode of the second transistor is electrically connected to the input terminal of the first inverter, and a second electrode of the second transistor is electrically connected to a second voltage terminal; and
wherein the first transistor is a p-type transistor, and the second transistor is an n-type transistor.

9. The driving circuit according to claim 1, wherein N is equal to 2, the inverting circuit comprises the first inverter and a second inverter, the first inverter comprises a first transistor and a second transistor, and the second inverter comprises a third transistor and a fourth transistor;
wherein a gate electrode of the first transistor is electrically connected to the input terminal of the first inverter, a first electrode of the first transistor is electrically connected to a first voltage terminal, and a second electrode of the first transistor and a first electrode of the second transistor are both electrically connected to an input terminal of the second inverter;
wherein a gate electrode of the second transistor is electrically connected to the input terminal of the first inverter, and a second electrode of the second transistor is electrically connected to a second voltage terminal;
wherein a gate electrode of the third transistor and a gate electrode of the fourth transistor are both electrically connected to the input terminal of the second inverter, a first electrode of the third transistor is electrically connected to the first voltage terminal, and a second electrode of the third transistor and a first electrode of the fourth transistor are both electrically connected to the driving signal output terminal;
wherein a second electrode of the fourth transistor is electrically connected to the second voltage terminal; and
wherein the first transistor is a p-type transistor, the second transistor is an n-type transistor; the third transistor is a p-type transistor, and the fourth transistor is an n-type transistor.

10. The driving circuit according to claim 2, wherein the first data writing circuit comprises a fifth transistor and a first capacitor;
wherein a gate electrode of the fifth transistor is electrically connected to the switch control terminal, a first electrode of the fifth transistor is electrically connected to the first data line, and a second electrode of the fifth transistor is electrically connected to the first differential control node; and
wherein a first terminal of the first capacitor is electrically connected to the first differential control node, and a second terminal of the first capacitor is electrically connected to a second voltage terminal.

11. The driving circuit according to claim 4, wherein the second data writing circuit comprises a sixth transistor and a second capacitor, a gate electrode of the sixth transistor is electrically connected to the switch control terminal, a first electrode of the sixth transistor is electrically connected to the second data line, and a second electrode of the sixth transistor is electrically connected to the second differential control node; and
wherein a first terminal of the second capacitor is electrically connected to the second differential control node, and a second terminal of the second capacitor is electrically connected to the second voltage terminal.

12. The driving circuit according to claim 4, wherein the switch control circuit comprises a seventh transistor;
wherein a gate electrode of the seventh transistor is electrically connected to the on-off control terminal, a first electrode of the seventh transistor is electrically connected to the first output control node, and a second electrode of the seventh transistor is electrically connected to the second output control node.

13. The driving circuit according to claim 3, wherein the input control circuit comprises an eighth transistor, and the differential control circuit comprises a ninth transistor and a tenth transistor;
wherein a gate electrode of the eighth transistor is electrically connected to the output control terminal, a first electrode of the eighth transistor is electrically connected to the first voltage terminal, and a second electrode of the eighth transistor is electrically connected to the input node;
wherein a gate electrode of the ninth transistor is electrically connected to the first differential control node, a first electrode of the ninth transistor is electrically connected to the input node, and a second electrode of the ninth transistor is electrically connected to the first output node; and
wherein a gate electrode of the tenth transistor is electrically connected to the second differential control node, a first electrode of the tenth transistor is electrically connected to the input node, and a second electrode of the tenth transistor is electrically connected to the second output node.

14. The driving circuit according to claim 13, wherein the set circuit comprises an eleventh transistor and a twelfth transistor;
wherein a gate electrode of the eleventh transistor is electrically connected to the output control terminal, a first electrode of the eleventh transistor is electrically connected to the intermediate node, and a second electrode of the eleventh transistor is electrically connected to the second voltage terminal; and
wherein a gate electrode of the twelfth transistor is electrically connected to the output control terminal, a first electrode of the twelfth transistor is electrically connected to the driving output terminal, and a second electrode of the twelfth transistor is electrically connected to the second voltage terminal.

15. The driving circuit according to claim 14, wherein the eighth transistor is a p-type transistor, and the eleventh transistor and the twelfth transistor are n-type transistors; or, the eighth transistor is an n-type transistor, and the eleventh transistor and the twelfth transistor are p-type transistors.

16. The driving circuit according to claim 6, wherein the latch circuit comprises a thirteenth transistor, a fourteenth transistor, a fifteenth transistor, and a sixteenth transistor;
wherein a gate electrode of the thirteenth transistor is electrically connected to the driving output terminal, a first electrode of the thirteenth transistor is electrically connected to the intermediate node, and a second electrode of the thirteenth transistor is electrically connected to the second voltage terminal;
wherein a gate electrode of the fourteenth transistor is electrically connected to the intermediate node, a first electrode of the fourteenth transistor is electrically connected to the driving output terminal, and a second electrode of the fourteenth transistor is electrically connected to the second voltage terminal;
wherein a gate electrode of the fifteenth transistor is electrically connected to the driving output terminal, a first electrode of the fifteenth transistor is electrically connected to the first output node, and a second electrode of the fifteenth transistor is electrically connected to the intermediate node; and
wherein a gate electrode of the sixteenth transistor is electrically connected to the intermediate node, a first electrode of the sixteenth transistor is electrically connected to the second output node, and a second electrode of the sixteenth transistor is electrically connected to the driving output terminal.

17. The driving circuit according to claim 16, wherein the thirteenth transistor and the fourteenth transistor are n-type transistors, and the fifteenth transistor and the sixteenth transistor are p-type transistors.

18. A driving method, applied to the driving circuit according to claim 1, comprising:
providing, by the output circuit, the driving output signal via the driving output terminal based on the data voltage under control of the switch control signal and the output control signal; and
inverting, by the inverter comprised in the inverting circuit, the signal received by the input terminal of the inverter, to obtain the inverted signal, and outputting the inverted signal via the output terminal of the inverter.

19. The driving method according to claim 18, wherein the output circuit comprises a first data writing circuit, a differential control circuit, an input control circuit and an output control circuit, the output control circuit comprises a latch circuit and a set circuit, a frame time comprises a blanking period, the blanking period comprises a setting period and an output phase, the setting period comprises a reset phase, a data writing phase and a potential maintaining phase, and the driving method comprises:
in the reset phase, controlling, by the set circuit, connection between an intermediate node and a second voltage terminal and connection between the driving output terminal and the second voltage terminal under control of the output control signal;
in the data writing phase, writing, by the first data writing circuit, a first data voltage provided by a first data line into a first differential control node under control of the switch control signal;
in the potential maintaining phase, maintaining, by the first data writing circuit, a potential of the first differential control node; and
in the output phase, controlling, by the input control circuit, connection between an input node and a first voltage terminal under control of the output control signal; controlling, by the differential control circuit, a potential of a first output node and a potential of a second output node based on a potential of the input node under control of the potential of the first differential control node and a potential of the second differential control node; controlling, by the latch circuit, the potential of the driving output terminal based on the potential of the first output node and the potential of the second output node under control of a potential of the intermediate node.

20. The driving method according to claim 19, wherein the output circuit further comprises a second data writing circuit, and the driving method further comprises:
in the data writing phase, writing, by the second data writing circuit, a second data voltage provided by a second data line into the second differential control node under control of the switch control signal; and
in the potential maintaining phase, maintaining, by the second data writing circuit, the potential of the second differential control node;
and/or,
wherein the driving circuit further comprises a switch control circuit, the blanking period comprises an off phase, the off phase comprises the setting period, and the driving method further comprises:
in the off phase, controlling, by the switch control circuit, disconnection between the first output control node and the second output control node under control of an on-off control signal.

21. (canceled)

22. A display device, comprising a driving circuit; wherein the driving circuit comprises: an output circuit and an inverting circuit:
wherein the output circuit is electrically connected to an output control terminal, a switch control terminal, a data line and a driving output terminal, and is configured to provide a driving output signal via the driving output terminal based on a data voltage provided by the data line under control of a switch control signal provided by the switch control terminal and an output control signal provided by the output control terminal;
wherein the inverting circuit comprises N stages of inverters, N is a positive integer;
wherein an input terminal of a first inverter is electrically connected to the driving output terminal, and an output terminal of an N-th inverter is electrically connected to a driving signal output terminal;
wherein in a case that N is greater than 1, an output terminal of an m-th inverter is electrically connected to an input terminal of an (m+1)-th inverter, and m is a positive integer less than N; and
wherein the inverter is configured to invert a signal received by received by the input terminal of the inverter to obtain an inverted signal, and output the inverted signal via the output terminal of the inverter.
